(19) United States
(12) Patent Application Publication
(10) Pub. No.: US 2005/0084790 A1
(43) Pub. Date: Apr. 21, 2005

(54) Color developer composition and imaging element containing same

(75) Inventors: Kurt M. Schroeder, Spencerport, NY (US); Yongcai Wang, Webster, NY (US); Shiying Zheng, Webster, NY (US); James L. Bello, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/688,411

(22) Filed: Oct. 17, 2003

(51) Int. Cl. G03C 5/18

(52) U.S. Cl. 430/138; 430/464

(57) ABSTRACT

This invention relates to an aqueous dispersion composition comprising particles of a polyvalent metal salt of salicylic acid/styrene copolymer developer wherein said particles comprise at least 15% by weight of the aqueous composition and have an average particle size of greater than or equal to 0.75 μm and less than or equal to 2.0 μm, and wherein less than 2% of the particles are greater than 10 μm, wherein said composition has a pH of greater than 6 and comprises a surfactant and a polymeric dispersant. It further relates to a method of making said composition and an imaging element comprising said composition.

### FIELD OF THE INVENTION

This invention relates to compositions containing salicylic acid/styrene copolymer developer particles. It further relates to a light sensitive and heat developable or light sensitive and pressure developable imaging element comprising an image forming unit comprising photosensitive microcapsules and a salicylic acid/styrene copolymer developer. It further relates to a method of making the salicylic acid/styrene copolymer developer particles.

### BACKGROUND OF THE INVENTION

In recent years various dry-type image-imaging processes which utilize a color-forming component capable of generating visible images by coloration or discoloration reaction have been disclosed in the patent literature. These imaging processes do not use a liquid developing solution or the like and, therefore, do not generate wastes. Both light sensitive and heat developable and light sensitive and pressure developable processes have been discussed in great detail. Both processes utilize a photopolymerization composition to create a latent image by irradiating the imaging element with light through an image original or using a digital image file. The latent image is composed of domains exposed to light at different degrees (from unexposed to fully exposed areas). The fully exposed domains have the highest degree of hardening, and the unexposed domains have lowest degree of hardening. Under heat or pressure or both, a visible image is formed due to the difference in the mobility of the color-forming component, said mobility being controlled by the degree of hardening. For example, in the unexposed area the color-forming component can move freely to allow a color formation reaction, and in the fully exposed area the color-forming component cannot move, thereby inhibiting a color formation reaction. The color-forming components are al so called a leuco dye or electron donative compound, and the component which reacts with the color-forming component to form color is called color developer or electron receptive compound.

Imaging systems employing microencapsulated radiation sensitive compositions have been disclosed in U.S. Pat. Nos. 4,399,209: 4,416,966: 4,440,846; 4,766,050: and 5,783,353. These imaging systems are characterized in that an imaging sheet including a layer of microcapsules containing a photohardenable composition in the internal phase is image-wise exposed to light. In the most typical embodiments, the photohardenable composition is a photopolymerization composition including a polyethylenically unsaturated compound and a photoinitiator. A color former is encapsulated with the photopolymerization composition. Exposure to light hardens the internal phase of the microcapsules. Following exposure, the imaging sheet is developed by subjecting it to a uniform rupturing force in the presence of a developer.

An image transfer system in which the developer material is coated on a separate substrate as a separate developer or copy sheet is disclosed in U.S. Pat. No. 4,399,209. A self-contained imaging system in which the encapsulated color former and the developer material are present in one layer or in two interactive layers is disclosed in U.S. Pat. No. 4,440,846. Self-contained imaging systems having an opaque support are disclosed in commonly assigned U.S. Pat. No. 6,080,520. A two-sided imaging material is disclosed in commonly assigned U.S. Pat. No. 6,030,740.

The imaging system is capable of providing a full color imaging material in which the microcapsules are in three sets containing cyan, magenta, and yellow color formers respectively sensitive to red, green, and blue light. For good color balance, the light sensitive microcapsules are sensitive (X max) at about 420 to 480 nm, 500 to 560 nm, and 580 to 650 nm, respectively. Such a system is useful with visible light sources in direct transmission of reflection imaging. It is further useful in making contact prints, projected prints of color photographic slides, or in digital printing. It is also useful in electronic imaging using lasers or pencil light sources of appropriate wavelengths. Because digital imaging systems do not require the use of visible light, sensitivity can be extended into the UV and IR to spread the absorption spectra of the photoinitiators and avoid cross talk.

U.S. Pat. No. 5,783,353 discloses a self-contained imaging system wherein the imaging layer is sealed between two supports to form an integral unit (laminated structure). The sealed format is advantageous in that it can reduce oxygen permeation and improve stability of the media. U.S. Pat. No. 6,365,319 discloses a self-contained imaging assembly which has an imaging layer containing developer and photohardenable microcapsules placed between two support members, wherein one support is transparent, and one support is opaque and comprises a metallic barrier layer and exhibits a water vapor transmission rate of less than 0.77 g/m²/day (0.05 g/100 in²/day). U.S. Pat. No. 6,544,711B1 discloses a self-contained imaging system which has an imaging layer containing developer and photohardenable microcapsules placed between two support members, wherein at least one support is transparent and at least one support comprises a ceramic barrier layer and exhibits a water vapor transmission rate not more than about 0.47 g/m²/day (0.03 g/100 in²/day). While the laminated structure has improved media stability and protection against damage, the clear over-laminate through which one views the image degrades image sharpness and resolution. In addition, the laminated structure adds complexity and cost to manufacture.

U.S. Application 2002/0045121 A1 discloses a self-contained photosensitive material which includes an imaging layer of photosensitive microcapsules and a developer on a support and a protective coating on the imaging layer. The protective coating comprises a water-soluble or water-dispersible resin and provides scratch resistance and water resistance to the imaging media. The protective coating may also include a cross-linking agent, UV absorbing compounds, and pigments.

Color developers which have been proposed to date include inorganic solids such as clay and attapulgite, substituted phenols and biphenols, polyvalent metal salts of modified p-substituted phenol-formaldehyde resins, and polyvalent metal salts of aromatic carboxylic acids. Both polyvalent metal salts of modified p-substituted phenol-formaldehyde resins and polyvalent metal salts of aromatic carboxylic acid derivatives have been disclosed to be useful for imaging systems comprising microencapsulated imaging compositions. Polyvalent metal salts of modified p-substituted phenol-formaldehyde resins are excellent in color developing speed at low temperature However, they tend to cause imaging elements yellowing when exposed to radiation rays such as sunlight or during storage. Polyvalent metal salts of aromatic carboxylic acid derivatives such as polyvalent metal salts of 3,5-disubstituted salicylic acid derivatives or polyvalent metal salts of a salicylic acid resin obtained by reacting salicylates with styrene improves imaging element yellowing resistance. However their color developing ability needs to be optimized.

U.S. Pat. No. 6,383,982 discloses a color developer composition comprising an aqueous dispersion of a color developer containing a mutivalent polyvalent metal salt of a salicylic acid derivative and a polyester polyol. Such a composition was shown to have excellent color developability when used in pressure-sensitive recording sheets which include an upper sheet prepared by applying on one surface of a base material microcapsules comprising therein a capsule oil dissolving a color former, and an intermediate or lower sheet prepared by applying on one surface of a base material the color developer. Such a developer composition is not very useful when a pressure-sensitive recording sheet is prepared by applying a microencapsulated color former and the color developer in a single layer coat on a single base or in an adjacent layer in a single base. When such a pressure-sensitive recording sheet is subjected to high temperature and humidity treatment (>40° C.), the color developing ability of the color developer diminishes significantly.

There are many processes known in the art for making polyvalent metal salt of salicylic acid derivative used as color developer. For example, the polyvalent metal salt of salicylic acid resin can be produced by reacting salicylic acid with a benzyl alcohol derivative at elevated temperature as disclosed in U.S. Pat. No. 4,754,063. or they can be produced by reacting salicylic acid with a styrene derivative at elevated temperature as disclosed in U.S. Pat. No. 4,929,710 or by reacting salicylate ester with a styrene derivative at low temperature as disclosed in U.S. Pat. No. 4,952,648. Each method produces a developer resin with a different composition. The first two processes have the drawback of producing dark colored developer resin. The third process produces a developer resin with almost no or slight color.

Various methods of preparing an aqueous dispersion of a developer composition comprising a polyvalent metal salt of a salicylic acid derivative are known in the art. One method consists of grinding the developer in an aqueous medium with the use of a dispersing aid and mechanical energy, for example, a ball mill, attritor media mill, high speed impeller disperser and the like. This approach is capable of forming an aqueous dispersion of the developer composition; however, this method produces a wide distribution of particles that are difficult to control in average size.

It is still desired to provide a color developer composition which has excellent color developing speed and excellent dispersion stability. It is also desired to provide an imaging element obtained by using said composition which has excellent image quality and excellent color developability when subjected to high temperature and humidity treatment.

### SUMMARY OF THE INVENTION

This invention provides an aqueous dispersion composition comprising particles of a polyvalent metal salt of salicylic acid/styrene copolymer developer wherein said particles are at least 15% by weight of the aqueous composition and have an average particle size of greater than or equal to 0.75 μm and less than or equal to 2.0 μm, and wherein less than 2% of the particles are greater than 10 μm wherein said composition has a pH of greater than 6 and comprises a surfactant and a polymeric dispersant. This invention further provides a process of making an aqueous dispersion of particles of a polyvalent metal salt of salicylic acid/styrene copolymer developer, said particles having an average particle size of greater than or equal to 0.75 μm and less than or equal to 2.0 μm, and wherein less than 2% of the particles are greater than 10 μm, said process comprising:
(a) preparing an organic phase comprising one or more auxiliary solvents a polyvalent metal salt of salicylic acid/styrene developer and a surfactant:
(b) preparing a separate aqueous phase containing a water soluble polyermeric dispersant;
(c) dispersing the organic phase into the aqueous phase to form a dispersed composition; and
(d) removing the auxiliary solvent from the dispersed composition; wherein the pH maintained during the process is greater than 6.

This invention also provides an imaging element comprising a support and an image forming layer comprising photosensitive microcapsules and a developer comprising particles of a polyvalent metal salt of salicylic acid/styrene copolymer developer said particles having a styrene/salicylic acid ratio of greater than 2:1.

The developer composition utilized in the invention provides an imaging element with improved image quality and excellent color developability when subjected to high temperature and humidity treatment. The process used to make the developer composition allows for a well-controlled particle size and particle size distribution, and provides good dispersion stability. This results in a suspension having high active solids and a minimal amount of dispersing addenda. Further, after manufacturing the composition is ready for coating without further processing.

### DETAILED DESCRIPTION OF THE INVENTION

The aqueous dispersion composition of the invention comprises particles of a polyvalent metal salt of salicylic acid/styrene copolymer developer wherein said particles are at least 15% by weight of the aqueous composition. Preferably the particles are at least 25% and more preferably at least 40% by weight of the aqueous composition. The particles have an average particle size of greater than or equal to 0.75 μm and less than or equal to 2.0 μm. The composition has a well-controlled particle size distribution wherein less than 2% of the particles are greater than 10 μm, and more preferably less than 1% of the particles are greater than 10 μm. The composition has a pH of greater than 6 and comprises a surfactant and a polymeric dispersant.

The polyvalent metal salt of salicylic acid/styrene copolymer developer comprises a polyvalent salt of a salicylic acid derivative and a styrenic compound. Specific examples of the salicylic acid derivative include, but are not limited to, salicylic acid, 3-methylsalicylic acid, 6-ethylsalicylic acid, 5-isopropylsalicylic acid, 5-sec-butylsalicylic acid, 5-tert-butylsalicylic acid, 5-tert-amylsalicylic acid, 5-cyclohexylsalicylic acid, 5-n-octylsalicylic acid, 5-tert-octylsalicylic acid, 5-isononylsalicylic acid, 3-isododecylsalicylic acid, 5-isododecylsalicylic acid, 5-isopentadecylsalicylic acid, 4-methoxysalicylic acid, 6-methoxysalicylic acid, 5-ethoxysalicylic acid, 6-isopropoxysalicylic acid, 4-n-hexyloxylsalicylic acid, 4-n-decyloxylsalicylic acid, 3,5-di-tert-butylsalicylic acid 3,5-di-tert-octylsalicylic acid, 3,5-diisononylsalicylic acid, 3,5-diisododecylsalicylic acid, 3-methyl-5-tert-nonylsalicylic acid, 3-tert-butyl-5-isononylsalicylic acid, 3-isononyl-5-tert-butylsalicylic acid, 3-isododecyl-5-tert-butylsalicylic acid, 3-isononyl-5-tert-amylsalicylic acid, 3-isononyl-5-tert-octylsalicylic acid, 3-isononyl-6-methylsalicylic acid, 3-isododecyl-6-methylsalicylic acid, 3-sec-octyl-5-methylsalicylic acid, 3-isononyl-5-phenylsalicylic acid, 3-phenyl-5-isononylsalicylic acid, 3-methyl-5-(α-methylbenzyl)salicylic acid, 3-methyl-5-(α,α-dimethylbenzyl)salicylic acid, 3-isononyl-5-(α-methylbenzyl)salicylic acid, 3-(α-methylbenzyl)-5-tert-butylsalicylic acid, 3-benzylsalicylic acid, 5-benzylsalicylic acid, 3-(α-methylbenzyl)salicylic acid, 5-(α-methylbenzyl)salicylic acid, 3-(α,α-dimethylbenzyl)salicylic acid, 4-(α,α-dimethylbenzyl)salicylic acid, 5-(α,α-dimethylbenzyl)salicylic acid, 3,5-di(α-methylbenzyl)salicylic acid, 3,5-di(α,α-dimethylbenzyl)salicylic acid, 3-(α-methylbenzyl)-5-(α,α-dimethylbenzyl)salicylic acid, 3-(1′,3′-diphenylbutyl)salicylic acid, 5-(1′,3′-diphenylbutyl)salicylic acid, 3-[α-methyl-4′-(α′-methylbenzyl)benzyl]-salicylic acid, 5-[α-methyl-4′-(α′-methylbenzyl)benzyl]-salicylic acid, 3-(α-methylbenzyl)-5-(1′,3′-diphenyl-butyl)salicylic acid, 3-(1′,3′-diphenylbutyl)-5-(α-methylbenzyl)salicylic acid, 3-phenylsalicylic acid, 5-phenylsalicylic acid, 3-(α-methylbenzyl)-5-phenylsalicylic acid, 3-(α,α-dimethylbenzyl)-5-phenylsalicylic acid, 3-phenyl-5-(α-methylbenzyl)salicylic acid, 5-(4′-methylphenyl)salicylic acid, 5-(4′-methoxyphenyl)salicylic acid, 5-fluorosalicylic acid, 3-chlorosalicylic acid, 4-chlorosalicylic acid, 5-chlorosalicylic acid, 5-bromosalicylic acid, 3-chloro-5-(α-methylbenzyl)salicylic acid, 3-(α-methylbenzyl)-5-chlorosalicylic acid, and the like. Specific examples of the styrenic compound include, but are not limited to, styrene, o-methylstyrene, m-methylstyrene, p-methylstyrene, o-ethylstyrene, p-ethylstyrene, o-isopropylstyrene, m-isopropylstyrene, p-isopropylstyrene, p-terbutylstyrene, and α-methylstyrene, divinylbenzene, and styrene dimmers having the chemical formula: 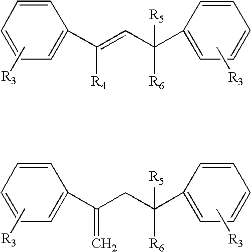
wherein R₃ is a hydrogen or an alkyl group having 1 to 4 carbon atoms, and R₄ to R₆ represent a hydrogen or a methyl group.

There are many processes known in the art for making salicylic acid/styrene compounds. For example, the polyvalent metal salt of salicylic acid resin can be produced by reacting salicylic acid with a benzyl alcohol derivative at elevated temperature as disclosed in U.S. Pat. No. 4,754,063. or they can be produced by reacting salicylic acid with a styrene derivative at elevated temperature as disclosed in U.S. Pat. No. 4,929,710, or by reacting salicylate ester with a styrene derivative at low temperature as disclosed in U.S. Pat. No. 4,952,648. Some of the processes form small molecules having a ratio of styrene to salicylic acid of 1:1 to 2:1. Others result in a mixture of copolymers having a ratio of styrene to salicylic acid of 1:1 to very large molecules with a molecular weight of 10,000 or more. The developer composition depends on the stoichiometry of the styrene derivative and salicylate used in the process. It may also depend on the type of reaction method utilized. It is preferred that the mole ratio of styrene derivative to salicylate used to make the salicylic acid/styrene polyvalent metal salt utilized in the invention be 2:1 to 7:1 mols, and more preferably 3:1 to 6:1 mols. In a preferred process salicylate ester is reacted with a styrene derivative at low temperature as disclosed in U.S. Pat. No. 4,952,648, incorporated herein by reference.

It is preferred that the salicylic acid/styrene polyvalent metal salt be a zinc salt, although other polyvalent metals such as aluminum, barium, lead, cadmium, calcium, chromium, iron, gallium, cobalt, copper, magnesium, manganese, molybdenum, nickel, mercury, silver, strontium, tantalum, titanium, vanadium, tungsten, tin, and zirconium may be utilized. Other preferred metals are aluminum, titanium, vanadium, and tin. It is preferred that the composition have a low residual zinc concentration.

The composition further comprises a water soluble polymeric dispersant and a surfactant which is soluble in an organic phase. Suitable water soluble polymeric dispersants and surfactants are described below. The composition may further comprise additives that are compatible with the salicylic acid/styrene polyvalent metal salt. Examples of such additives include antioxidants, light stabilizers such as UV absorbers, hindered amine light stabilizers, singlet oxygen quenchers, inorganic fillers, water insoluble resins such as epoxy resin, flow promoters or rheology modifiers, a hydrophobe such as hexadecane, and the like.

Many methods of forming particles of a polyvalent metal salt of salicylic acid/styrene copolymer are known in the art. Preferably the composition is made by the method of forming an aqueous dispersion of the developer composition by means of an organic solvent dispersion, which comprises the following steps.
(a) preparing an organic phase comprising one or more auxiliary solvents, a polyvalent metal salt of salicylic acid/styrene copolymer developer, and a surfactant:
(b) preparing a separate aqueous phase containing a water soluble polyermeric dispersant:
(c) dispersing the organic phase into the aqueous phase to form a dispersed composition; and
(d) removing the auxiliary solvent from the dispersed composition: wherein the pH maintained during the process is greater than 6.

The auxiliary organic solvent may be any solvent which will dissolve the polyvalent metal salt of salicylic acid/styrene copolymer developer. The amount of low boiling organic solvent used to dissolve the developer composition is not particularly limiting however, a minimum amount of solvent is preferred in order to facilitate evaporation of the solvent after droplet formation. Useful ranges of organic solvent to developer composition on a weight basis vary from about 0.2:1 to 20:1, more preferably from about 0.5:1 to 10:1. and most preferably from about 0.5:1 to about 5:1.

Examples of useful organic solvents, preferably low boiling, include: propyl acetate, isopropyl acetate, ethyl acetate, acetone, methyl ethyl ketone, dichloroethane, methyl isobutyl ketone, isopropanol, isobutanol, toluene, xylene, dichloromethane, and the like. Preferred solvents include propyl acetate, isopropyl acetate, ethyl acetate, methyl ethyl ketone, dichloroethane, toluene, dichloromethane. Any combination of low boiling organic solvents may be used to dissolve the developer composition, and the mixture may be heated to below the boiling point of the organic solvent to achieve complete dissolution of the developer composition.

The surfactant useful for the practice of the present invention may be dissolved in the organic phase to control the average particle size, width of the distribution of particles, and colloidal stability of the aqueous suspension. The amount of surfactant added to the organic phase is not particularly restricted. Typical amounts range from 0.01% to 10% of the organic phase, and preferably from 0.01% to 5%. and more preferably from 0.1% to 5%. Surfactants that can be used in the organic phase include, for example, a sulfate, a sulfonate, a cationic compound. or an amphioteric compound, and an oil soluble polymeric protective colloid. Specific examples are described in “MCCUTCHEON'S Vol. 1: Emulsifiers & Detergents, 1995. North American Edition” and include, for example, alkali polyvalent metal salts of alkylbenzene sulfonic acids, substituted naphthalene sulfonic acids, alkylsulfosuccinic acids, alkyl diphenyl oxide sulfonic acids, alpha olephin sulfonic acids, alkyl polyglycosides, ethoxylated alkyl phenols, ethoxylated alcohols, polyglycidols, and block copolymers of ethoxylated/propoxylated alcohols. The preferred surfactant is an alkali salt of an alkylsulfosuccinic acid.

The water soluble polymeric dispersants useful in the aqueous phase include, but are not limited to, polyacrylamide, polyvinyl alcohol, polyvinyl pyrrolidone, sulfonated polyvinyl alcohol, carboxylated polyvinyl alcohol, sulfonated polystyrene, polyacrylic acid, maleic anydride-vinyl copolymers, carboxymethylcellulose, hydroxyethylcellulose, gelatin, and the like. The preferred water soluble polymeric dispersant is polyvinyl alcohol.

Surfactants which may be added to the aqueous phase are preferably water soluble surfactants and include, but are not limited to, a sulfate, a sulfonate, a cationic compound, or an amphoteric compound. Specific examples are described in “McCUTCHEON'S Vol. 1: Emulsifiers & Detergents, 1995, North American Edition” and include, for example, alkali polyvalent metal salts of alkylbenzene sulfonic acids, substituted naphthalene sulfonic acids, alkylsulfosuccinic acids, alkyl diphenyl oxide sulfonic acids, alpha olephin sulfonic acids, alkyl polyglycosides, ethoxylated alkyl phenols, ethoxylated alcohols, polyglycidols, and block copolymers of ethoxylated/propoxylated alcohols.

The organic phase may be dispersed into the aqueous phase using any known dispersing method, preferably a high sheer method, and preferably by means of a mechanical mixer such as a rotor-stator mixer, a homogenizer, a microfluidizer and the like. There is no restriction on the addition of phases, as the organic phase may be added to the aqueous phase or the aqueous phase may be added to the organic phase, provided that sufficient agitation is applied during mixing.

The pH utilized in the process for the developer dispersion making is preferably greater than 6. Preferably the pH value of the finished dispersion is also greater than 6. The organic solvent is then removed using suitable temperature and pressure so as to evaporate the solvent from the aqueous dispersion. It is highly preferred that there be nearly complete removal of the organic solvent in order to achieve good stability of the particles of the developer composition of the present invention. The residual volatile organic solvent must be less than about 2%, more preferably less than 1%, and most preferably less than about 0.5% by weight of the final aqueous dispersion.

Preferably a pH adjustment step follows the solvent evaporation step whereby the pH of the resulting aqueous dispersion of the developer composition is raised to above 8.0, and preferably above 9.0. This may be accomplished with any suitable base including, for example, sodium hydroxide, potassium hydroxide, triethanol amine, N,N-dimethyl ethanolamine, triethylamine, and the like. The final concentration of solids in the aqueous dispersion is about 50% solids or less and can be achieved by further distillation of water from the dispersion once the volatile organic solvent is removed.

The preferred method of forming the aqueous dispersion of a developer composition is capable of producing well-controlled and narrow particle size droplets. The average particle size of the droplets is from about 0.75 μm to about 2 μm. The particle size distribution may be produced such that the volume fraction of particles above 10 μm is generally less than 2%, and more preferably 1% of the distribution. This may be measured by the methods known in the art such as light scattering or coulter counter method.

It is preferred that the ratio of styrene derivative to salicylate used to make the polyvalent metal salt of salicylic acid/styrene copolymer is 2:1 mols to 7:1 mols. More preferably the ratio of styrene derivative to salicylate used lo make the polyvalent metal salt of salicylic acid/styrene copolymer is 3:1 mols to 6:1 mols.

The invention further comprises an imaging element comprising a support and an image forming layer comprising photosensitive microcapsules and a developer comprising particles of a polyvalent metal salt of salicylic acid/styrene copolymer developer, said particles having a styrene/salicylic acid ratio of greater than 2:1 mols. Preferably the particles have a styrene/salicylic acid ratio of greater than 3:1 mols 25. In one embodiment the particles have an average particle size of greater than or equal to 0.75 μm and less than or equal to 2.0 μm, and less than 2% of the particles are greater than 10 μm. Preferably less than 1% of the particles are greater than 10 μm.

In one embodiment the developer particles are prepared by the method of forming an aqueous dispersion of the developer composition by means of an organic solvent dispersion, as described in detail above. Preferably the invention comprises an imaging element comprising a support having a light sensitive and heat developable image forming unit or a light sensitive and pressure developable image forming unit provided thereon. In a preferred embodiment the element comprises an image forming unit which is light sensitive and pressure developable, i.e., it is exposed by light and developed by applying pressure. The image forming unit of the various element types may comprise one layer or more than one layer. At least one layer comprises a color-forming component that is preferably enclosed in a microcapsule. At least one layer comprises the color developer particles of the invention. The microcapsules and the developer particles may be in the same layer or in different layers. Preferably they are in the same layer. Preferably the microcapsules are light sensitive. More preferably the microcapsules are both light and pressure sensitive.

The light sensitive microcapsules useful for the practice of the invention comprise a color-forming component, a polymerizable compound, and a photopolymerization initiator. In the light sensitive and pressure developable imaging element, exposure to light according to a desired image causes the polymerizable compound present inside the microcapsules to harden the microcapsule interior by a polymerization reaction due to the radical generated from the photopolymerization initiator upon exposure so that a latent image in a desired shape is formed. That is, in the exposed portions, the color-forming reaction with the developer particles present outside the microcapsules is inhibited. Next, when pressure is applied to the imaging element, the microcapsules which have not hardened (the unexposed microcapsules) are broken which cause the color-forming component to move within the unexposed area to react with the developer particles to develop a color. Accordingly, the light sensitive and pressure developable image-imaging element is a positive-type, light sensitive and pressure developable imaging element in which the image formation is performed such that color formation is not made in exposed portions but color formation is made in the unexposed portions that do not harden.

The color-forming component A useful for the practice of the invention include an electron-donating, colorless dye such that the dye reacts with the developer utilized in the invention to develop a color. Specific examples of these color-forming components include those described in Chemistry and Applications of Leuco Dye, Edited by Ramaiah Muthyala, Plenum Publishing Corporation, 1997. Representative examples of such color formers include substantially colorless compounds having in their partial skeleton a lactone, a lactam, a sultone, a spiropyran, an ester or an amido structure. More specifically, examples include triarylmethane compounds, bisphenylmethane compounds, xanthene compounds, thiazine compounds and spiropyran compounds. Typical examples of the color formers include Crystal Violet lactone, benzoyl leuco methylene blue, Malachite Green Lactone, p-nitrobenzoyl leuco methylene blue, 3-dialkylamino-7-dialkylamino-fluoran, 3-methyl-2,2′-spirobi(benzo-f-chrome), 3,3-bis(p-dimethylaminophenyl)phthalide, 3-(p-dimethylaminophenyl)-3-(1,2 dimethylindole-3-yl)phthalide, 3-(p-dimethylaminophenyl)-3-(2-methylindole-3-yl)phthalide, 3-(p-dimethylaminophenyl)-3-(2-phenylindole-3-yl)phthalide, 3,3-bis(1,2-dimethylindole-3-yl)-5-dimethylaminophthalide, 3,3-bis-(1,2-dimethylindole-3-yl)6-dimethylaminophthalide, 3,3-bis-(9-ethylcarbazole-3-yl)-5-dimethylaminophthalide, 3,3-bix(2-phenylindole-3-yl)-5-dimethylaminophthalide, 3-p-dimethylaminophenyl-3-(1-methyl pyrrole-2-yl)-6-dimethylaminophthalide, 4,4′-bis-dimethylaminobenzhydrin benzyl ether, N-halophenyl leuco Auramine, N-2,4,5-trichlorophenyl leuco Auramine, Rhodamine-B-anilinolactam, Thodamine-(p-nitroanilino)lactam. Rhodamine-B-(p-chloroanilino)lactam, 3-dimethylamino-6-methoxyfluoran, 3-diethylamino-7-methoxyfluoran, 3-diethylamino-7-chloro-6-methylfluoroan, 3-diethylamino-6-methyl-7-anilinofluoran, 3-diethylamino-7-(acetylmethylamino)fluoran, 3-diethylamino-7-(dibenzylamino)fluoran, 3-diethylamino-7-(methylbenzylamino)fluoran, 3-diethylamino-7-(chloroethylmethylamino)fluoran, 3-diethylamino-7-(diethylamino)fluoran, 3-methyl-spiro-dinaphthopyran, 3,3′-dichloro-spiro-dinaphthopyran, 3-benzyl-spiro-dinaphthopyran, 3-methyl-naphtho-(3-methoxybenzo)-spiropyran, 3-propyl-spirodibenzoidipyran, etc. Mixtures of these color precursors can be used if desired. Also useful in the present invention are the fluoran color formers disclosed in U.S. Pat. No. 3,920,510, which is incorporated by reference. In addition to the foregoing dye precursors, fluoran compounds such as disclosed in U.S. Pat. No. 3,920,510 can be used. In addition, organic compounds capable of reacting with heavy metal salts to give colored metal complexes, chelates, or salts can be adapted for use in the present invention.

The polymerizable compound is an addition polymerizable compound selected from among the compounds having at least one, preferably two or more, ethylenically unsaturated bond at terminals. Such compounds are well known in the industry and they can be used in the present invention with no particular limitation. Such compounds have, for example, the chemical form of a monomer, a prepolymer, i.e., a dimer, a trimer, and an oligomer or a mixture and a copolymer of them. As examples of monomers and copolymers thereof, unsaturated carboxylic acids (e.g., acrylic acid, methacrylic acid, itaconic acid; crotonic acid, isocrotonic acid, maleic acid, etc.), and esters and amides thereof can be exemplified, and preferably esters of unsaturated carboxylic acids and aliphatic polyhydric alcohol compounds, and amides of unsaturated carboxylic acids and aliphatic polyhydric amine compounds are used. In addition, the addition reaction products of unsaturated carboxylic esters and amides having a nucleophilic substituent such as a hydroxyl group, an amino group and a mercapto group with monofunctional or polyfunctional isocyanates and epoxies, and the dehydration condensation reaction products of these compounds with monofunctional or polyfunctional carboxylic acids are also preferably used. The addition reaction products of unsaturated carboxylic esters and amides having electrophilic substituents such as an isocyanato group and an epoxy group with monofunctional or polyfunctional alcohols, amines and thiols, and the substitution reaction products of unsaturated carboxylic esters and amides having releasable substituents such as a halogen group and a tosyloxy group with monofunctional or polyfunctional alcohols, amines and thiols are also preferably used. As another example, it is also possible to use compounds replaced with unsaturated phosphonic acid, styrene, vinyl ether, etc., in place of the above-unsaturated carboxylic acids.

Specific examples of ester monomers of aliphatic polyhydric alcohol compounds and unsaturated carboxylic acids include, as acrylates, ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl) ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate, polyester acrylate oligomer, etc. As methacrylates, examples include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, and bis[p-(3-methacryloxy-2-hydroxy-propoxy)phenyl]dimethylmethane, bis[p-(methacryloxyethoxy)-phenyl]dimethylmethane. As itaconates, examples include ethylene glycol diiiaconate, propylene glycol diitaconate, 1,3-butanediol diitaconate, 1,4-butanediol diitaconate, tetramethylene glycol diitaconate, pentaerythritol diitaconate, and sorbitol tetraitaconate. As crotonates, examples include ethylene glycol dicrotonate, tetramethylene glycol dicrotonate, pentaerythritol dicrotonate, and sorbitol tetradicrotonate. As isocrotonates, examples include ethylene glycol diisocrotonate, pentaerythritol diisocrotonate, and sorbitol tetraisocrotonate. As maleates, examples include ethylene glycol dimaleate, triethylene glycol dimaleate, pentaerythritol dimaleate, and sorbitol tetramaleate. Further, the mixtures of the above-described ester monomers can also be used. Further, specific examples of amide monomers of aliphatic polyhydric amine compounds and unsaturated carboxylic acids include methylenebis-acrylamide, methylenebis-methacrylamide, 1,6-hexamethylenebis-acrylamide, 1,6-hexamethylenebis-methacrylamide, diethylenetriaminetris-acrylamide, xylylenebis-acrylamide, and xylylenebis-methacrylamide.

Further, urethane-based addition polymerizable compounds which are obtained by the addition reaction of an isocyanate and a hydroxyl group are also preferably used in the present invention. A specific example is a vinyl urethane compound having two or more polymerizable vinyl groups in one molecule, which is obtained by the addition of a vinyl monomer having a hydroxyl group represented by the following formula (V) to a polyisocyanate compound having two or more isocyanate groups in one molecule.
CH₂═C(R)COOCH₂CH(R′)OH
wherein R and R′ each represents H or CH₃.

Other examples include polyfunctional acrylates and methacrylates, such as polyester acrylates, and epoxy acrylates obtained by reacting epoxy resins with (meth)acrylic acids. Moreover, photo-curable monomers and oligomers listed in Sartomer Product Catalog by Sartomer Company Inc. (1999) can be used as well.

The details in usage of the addition polymerizable compound, e.g., what structure is to be used, whether the compound is to be used alone or in combination, or what an amount is to be used, can be optionally set up according to the final design of the characteristics of the photosensitive material. For example, the conditions are selected from the following viewpoint. For the photosensitive speed, a structure containing many unsaturated groups per molecule is preferred and in many cases bifunctional or more functional groups are preferred. For increasing the strength of an image part, i.e., a cured film, trifunctional or more functional groups are preferred. It is effective to use different functional numbers and different polymerizable groups (e.g., acrylate, methacrylate, styrene compounds, vinyl ether compounds) in combination to control both photosensitivity and strength. Compounds having a large molecular weight or compounds having high hydrophobicity are excellent in photosensitive speed and film strength, but may not be preferred from the point of development speed and precipitation in a developing solution. The selection and usage of the addition polymerizable compound are important factors for compatibility with other components (e.g., a binder polymer, an initiator, a colorant, etc.) in the photopolymerization composition and for dispersibility. For example, sometimes compatibility can be improved by using a low purity compound or two or more compounds in combination. Further, it is also possible to select a compound having specific structure for the purpose of improving the adhesion property of a support and an overcoat layer. Concerning the compounding ratio of the addition polymerizable compound in a photopolymerization composition, the higher the amount, the higher the sensitivity. But, too large an amount sometimes results in disadvantageous phase separation, problems in the manufacturing process due to the stickiness of the photopolymerization composition (e.g., manufacturing failure resulting from the transfer and adhesion of the photosensitive material components), and precipitation from a developing solution. The addition polymerizable compound may be used alone or in combination of two or more. In addition, appropriate structure, compounding ratio and addition amount of the addition polymerizable compound can be arbitrarily selected taking into consideration the degree of polymerization hindrance due to oxygen, resolving power fogging characteristic, refractive index variation and surface adhesion. Further, the layer constitution and the coating method of undercoating and overcoating can be performed according to circumstances.

Various photoinitiators can be selected for use in the above-described imaging systems. However by far the most useful photoinitators consist of an organic dye and an organic borate salt such as disclosed in U.S. Pat. No. Nos. 5,112,752: 5,100,755: 5,057,393: 4,865,942; 4,842,980; 4,800,149; 4,772,530; and 4,772,541. The photoinitiator is preferably used in combination with a disulfide coinitiator as described in U.S. Pat. No. 5,230,982 and an autoxidizer which is capable of consuming oxygen in a free radical chain process.

The amount of organic dye to be used is preferably in the range of from 0.1 to 5% by wveight based on the total weight of the photoplymerization compositions preferably from 0.2 to 3% by weight. The amount of borate compound contained in the photopolymerization composition of the invention is preferably from 0.1% to 20% by weight based on the total amount of photopolymerization composition, more preferably from 0.3 to 5% by weight, and most preferably from 0.3% to 2% by weight.

The ratio between the organic dye and organoborate salt is important from the standpoint of obtaining high sensitivity and sufficient decolorization by the irradiation of light in the fixing step of the recording process described later. The weight ratio of the organic dye to the organoborate salt is preferably in the range of from 2/1 to 1/50, more preferably less than 1/1 to 1/20, most preferably from 1/1 to 1/10.

The organic dyes for use in the present invention may be suitably selected from conventionally known compounds having a maximum absorption wavelength falling within a range of 300 to 1000 nm. High sensitivity can be achieved by selecting a desired dye having the wavelength range within described above and adjusting the sensitive wavelength to match the light source to be used. Also, it is possible to suitably select a light source such as blue, green, or red, or infrared LED (light emitting diode), solid state laser, OLED (organic light emitting diode) or laser, or the like for use in image-wise exposure to light.

Specific examples of the organic dyes include 3-ketocoumarin compounds, thiopyrylium salts, naphthothiazolemerocyanine compounds, merocyanine compounds, and merocyanine dyes containing thiobarbituric acid. hemioxanole dyes, and cyanine, hemicyanine, and merocyanine dyes having indolenine nuclei. Other examples of the organic dyes include the dyes described in Chemistry of Functional Dyes (1981, CMC Publishing Co., Ltd., pp.393-416) and Coloring Materials (60[4], 212-224, 1987). Specific examples of these organic dyes include cationic methine dyes, cationic carbonium dyes, cationic quinoimine dyes, cationic indoline dyes, and cationic styryl dyes. Examples of the above-mentioned dyes include keto dyes such as coumarin dyes (including ketocoumarin and sulfonocoumarin), merostyryl dyes, oxonol dyes, and hemioxonol dyes, nonketo dyes such as nonketopolymethine dyes, triarylmethane dyes, xanthene dyes, anthracene dyes, rhodamine dyes, acridine dyes, aniline dyes, and azo dyes; nonketopolymethine dyes such as azomethine dyes, cyanine dyes, carbocyanine dyes, dicarbocyanine dyes, tricarbocyanine dyes, hemicyanine dyes, and styryl dyes; quinoneimine dyes such as azine dyes, oxazine dyes, thiazine dyes, quinoline dyes, and thiazole dyes.

Preferably the organic dye useful for the invention is a cationic dye-borate anion complex formed from a cationic dye and an anionic organic borate. The cationic dye absorbs light having a maximum absorption wavelength falling within a range from 300 to 1000 nm and the anionic borate has four R groups, of which three R groups each represents an aryl group which may have a substitute, and one R group is an alkyl group, or a substituted alkyl group. Such cationic dye-borate anion complexes have been disclosed in U.S. Pat. No. Nos. 5,112,752; 5,100,755: 5,075,393: 4,865,942; 4,842,980; 4,800,149; 4,772,530; and 4,772,541 which are incorporated herein by reference.

When the cationic dye-borate anion complex is used as the organic dye in the photopolymerization compositions of the invention, it does not require to use the organoborate salt. However, to increase the photopolymerization sensitivity and to reduce the cationic dye stain, it is preferred to use an organoborate salt in combination with the cationic dye-borate complex. The organic dye can be used singly or in combination.

Specific examples of the above-mentioned water insoluble phenols are given below. However, it should be noted that the present invention is not limited to these examples.

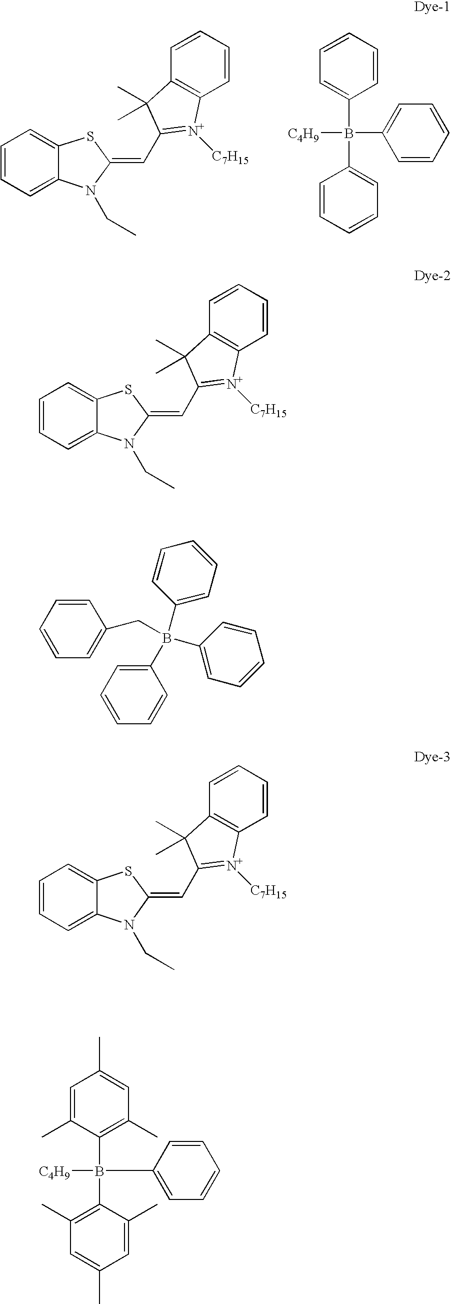

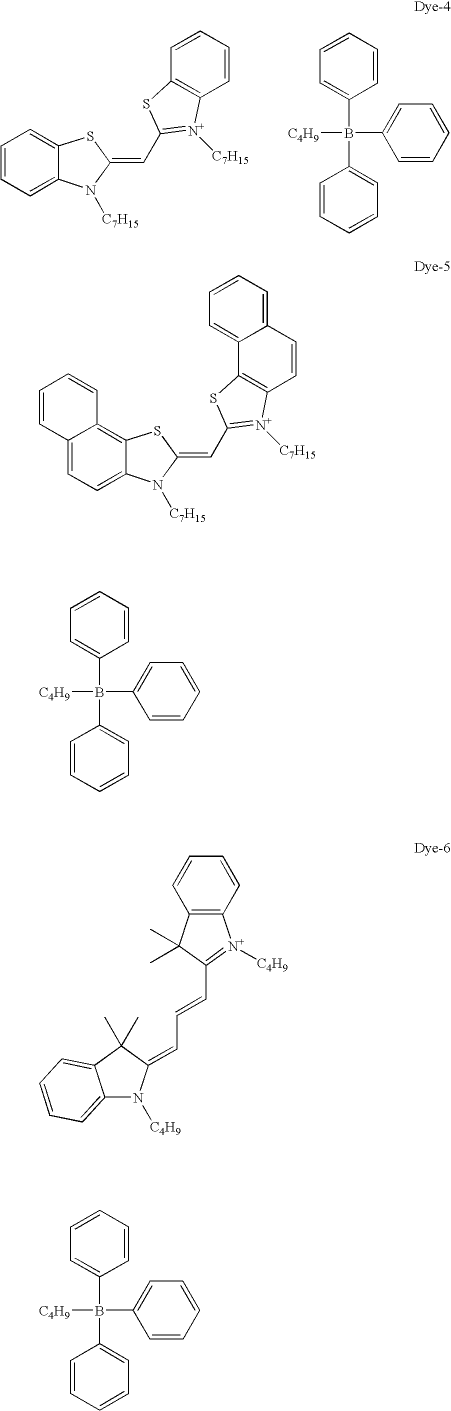

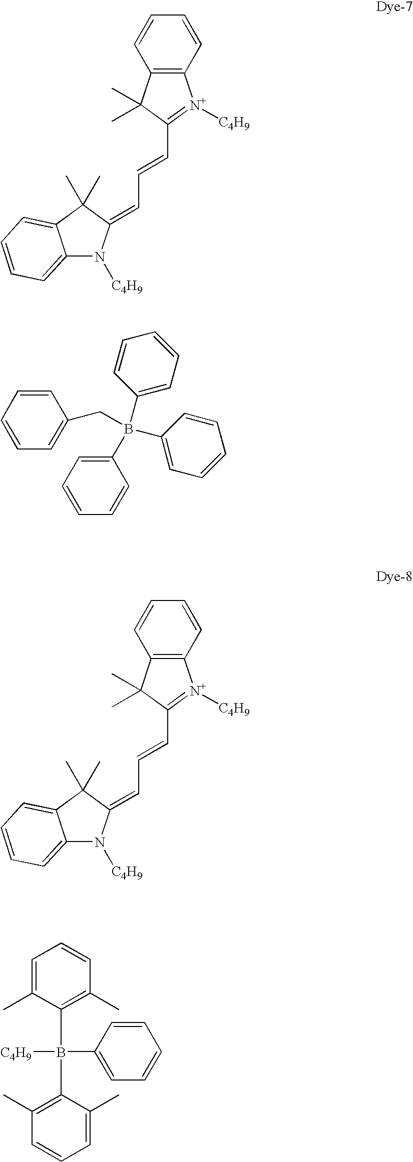

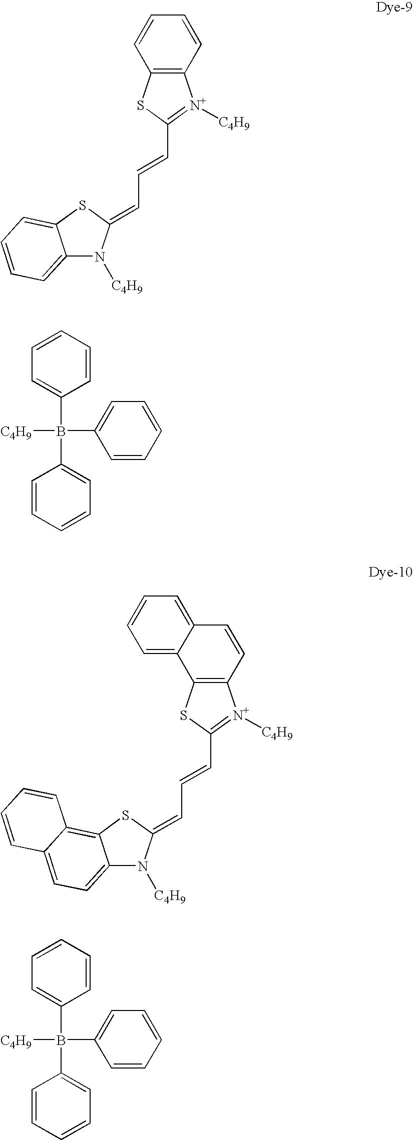

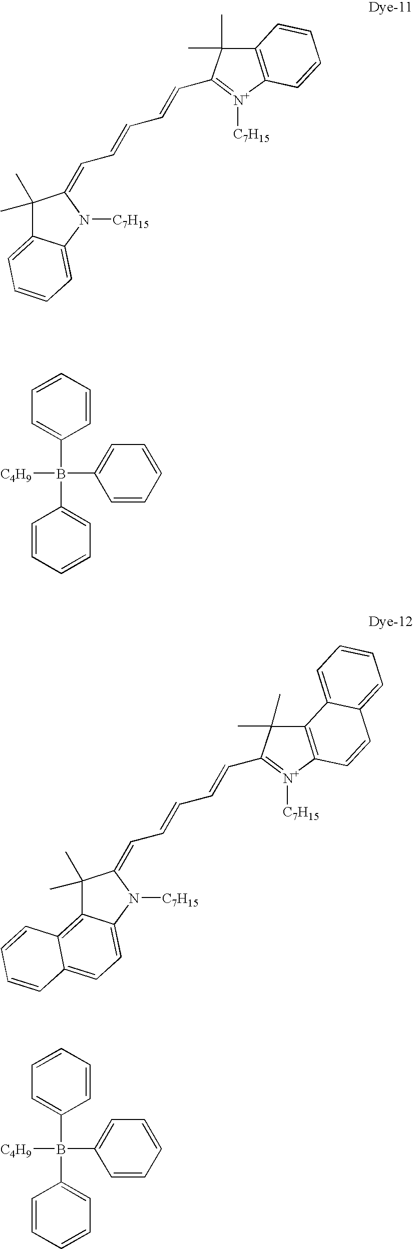

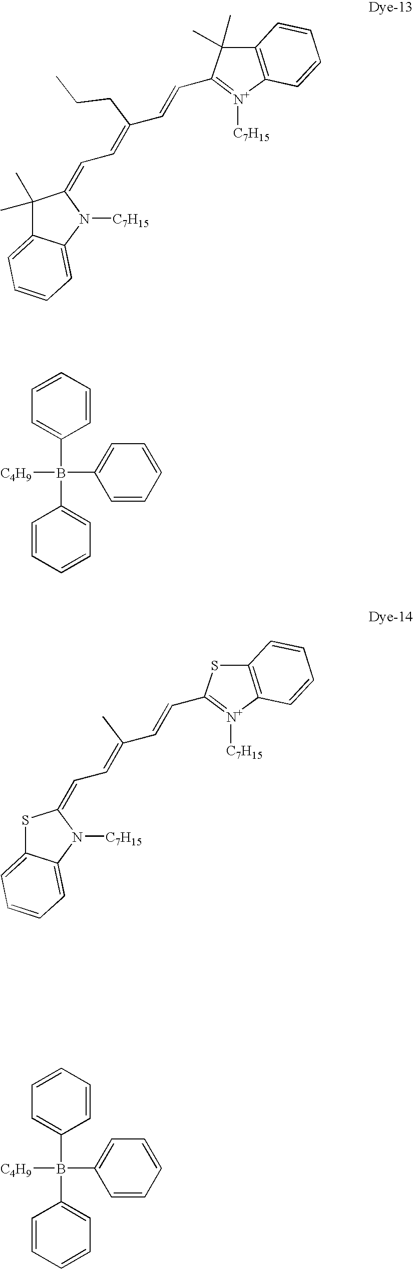

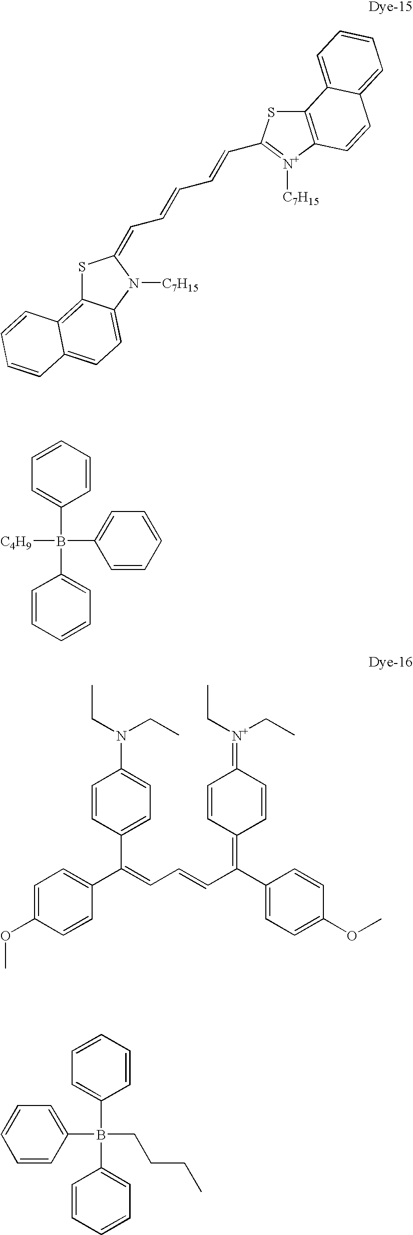

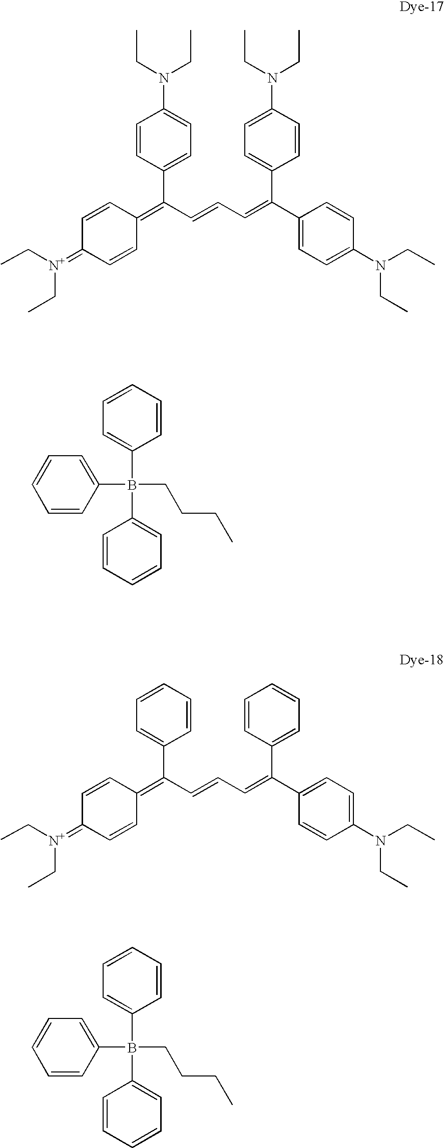

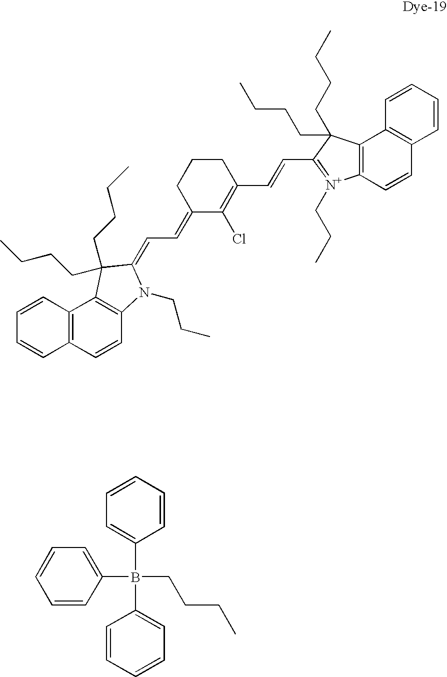

The borate salt useful for the photosensitive composition of the present invention is represented by the following general formula (1):
[BR₄]⁻Z⁺ [1]

where Z represents a group capable of forming cation and is not light sensitive, and [BR₄]⁻ is a borate compound having four R groups which are selected from an alkyl group, a substituted alkyl group, an aryl group, a substituted aryl group, an aralkyl group, a substituted aralkyl group, an alkaryl group, a substituted alkaryl group, an alkenyl group, a substituted alkenyl group, an alkynyl group, a substituted alkynyl group, an alicyclic group, a substituted alicyclic group, a heterocyclic group, a substituted heterocyclic group, and a derivative thereof. Plural Rs may be the same as or different from each other. In addition, two or more of these groups may join together directly or via a substituent and form a boron-containing heterocycle. Z⁺ does not absorb light and represents an alkali metal, quaternary ammonium, pyridinium, quinolinium, diazonium, morpholinium, tetrazolium, acridinium, phosphonium, sulfonium, oxosulfonium, iodonium, S, P, Cu, Ag, Hg, Pd, Fe, Co, Sn, Mo, Cr, Ni, As, or Se.

Specific examples of the above-mentioned borate salts are given below. However, it should be noted that the present invention is not limited to these examples.

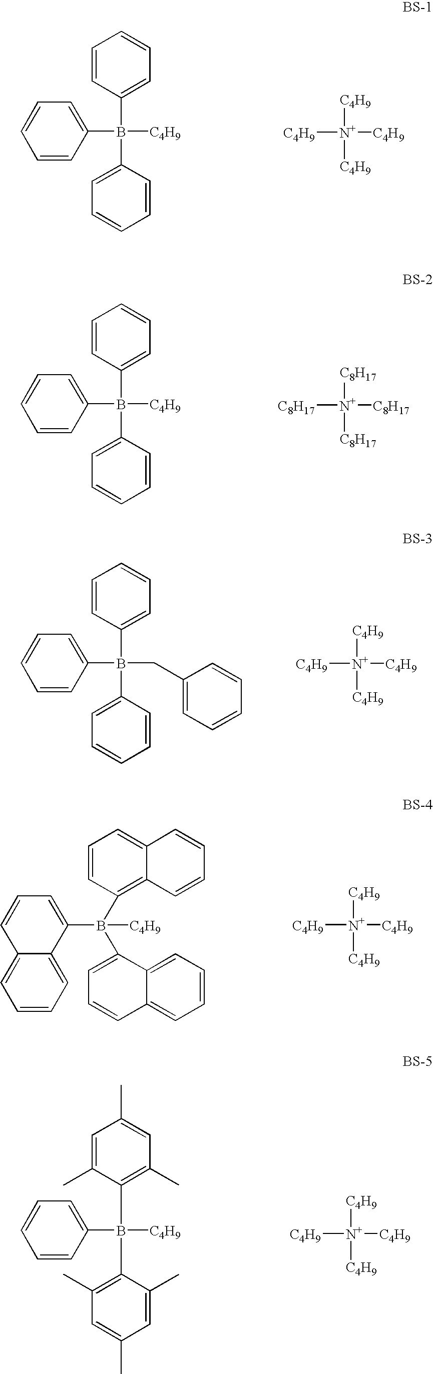

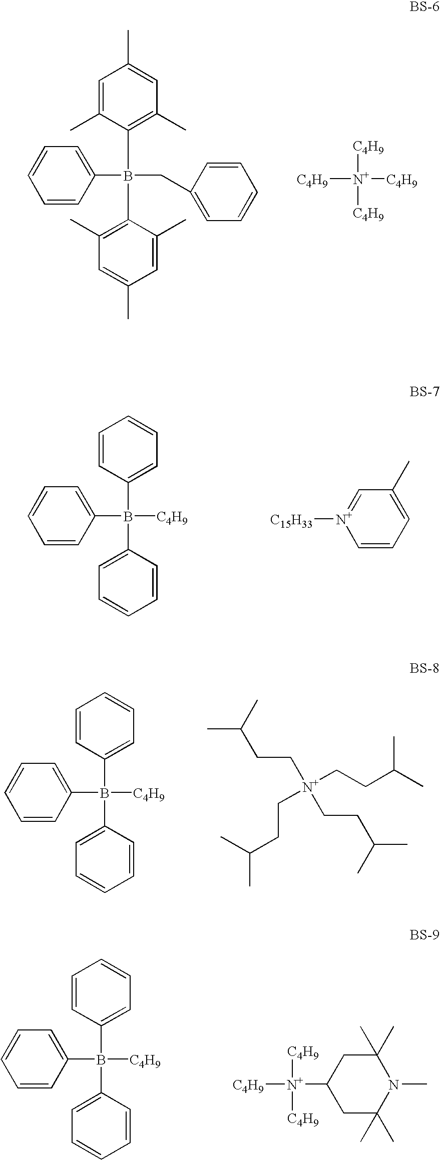

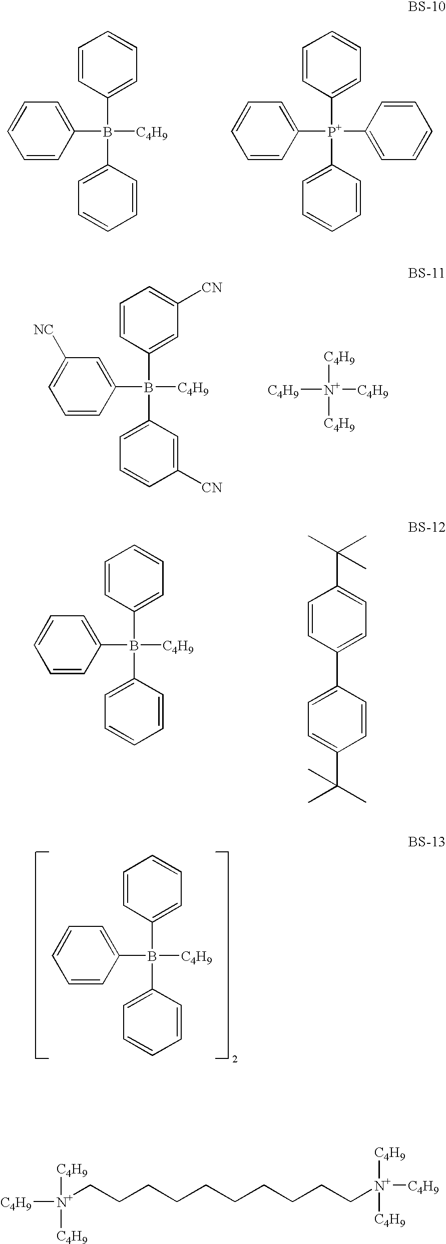

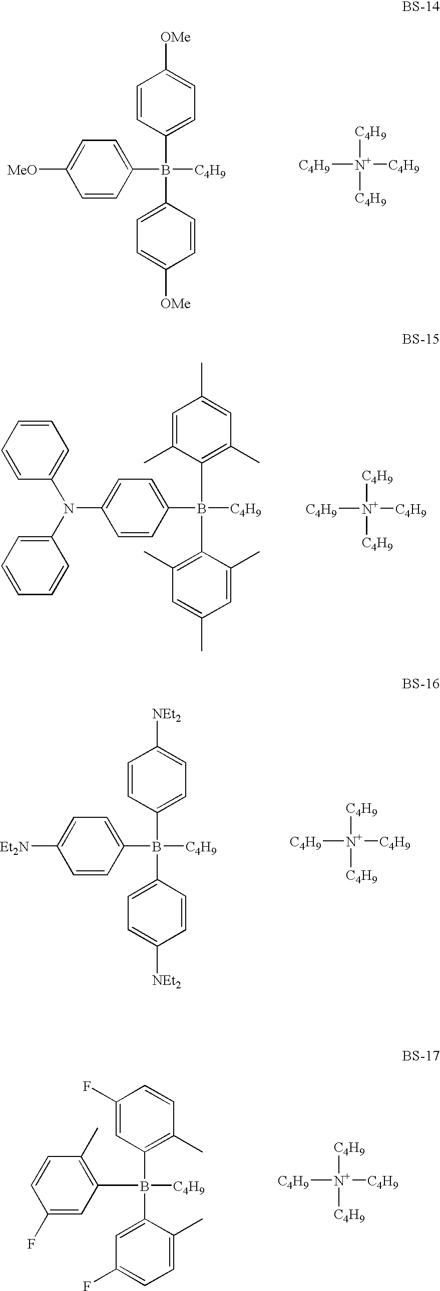

Various additives can he used together with the photoinitiator system to affect the polymerization rate. For example, a reducing agent such as an oxygen scavenger or a chain-transfer aid of an active hydrogen donor, or other compound can be used to accelerate the polymerization. An oxygen scavenger is also known as an autoxidizer and is capable of consuming oxygen in a free radical chain process. Examples of useful autoxidizers are N,N-dialkylanilines. Examples of preferred N,N-dialkylanilines are dialkylanilines substituted in one or more of the ortho-, meta-, para-position by the following groups: methyl, ethyl, isopropyl, t-butyl, 3,4-tetramethylene, phenyl, trifluoromethyl, acetyl, ethoxycarbonyl, carboxy, carboxylate, trimethylsilymethyl trimethylsilyl, triethylsilyl, trimethylgermanyl, triethylgermanyl, trimethylstannyl, triethylstannyl, n-butoxy, n-pentyloxy, phenoxy, hydroxy, acetyl-oxy, methylthio, ethylthio, isopropylthio, thio-(mercapto-), acetylthio, fluoro, chloro, bromo and iodo. Representative examples of N,N-dialkylanilines useful in the present invention are 4-cyano-N,N-dimethylaniline, 4-acetyl-N,N-dimethylaniline, 4-bromo-N,N-dimethylaniline, ethyl 4-(N,N-dimethylamino)benzoate, 3-chloro-N,N-dimethylaniline, 4-chloro-N,N-dimethylaniline, 3-ethoxy-N,N-dimethylaniline, 4-fluoro-N,N-dimethylaniline, 4methyl-N,N-dimethylaniline, 4-ethoxy-N,N-dimethylaniline, N,N-dimethylaniline, N,N-dimethylthioanieidine, 4-amino-N,N-dimethylaniline, 3-hydroxy-N,N-dimethylaniline, N,N,N′,N′-tetramethyl-1,4-dianiline, 4-acetamido-N,N-dimethylaniline, 2,6-diisopropyl-N,N-dimethylaniline (DIDMA), 2,6-diethyl-N,N-dimethylaniline, N,N,2,4,6-pentamethylaniline (PMA) and p-t-butyl-N,N-dimethylaniline. In accordance with another aspect of the invention, the dye borate photoinitiator is used in combination with a disulfide coinitiator.

Examples of useful disulfides are described in U.S. Pat. No. 5,230,982 which is incorporated herein by reference. Two of the most preferred disulfides are mercaptobenzothiazo-2-yl disulfide and 6-ethoxymercaptobenzothiazol-2-yl disulfide. By using these disulfides as described in the referenced patent, the amount of the photoiniitiators used in the microcapsules can be reduced to levels such that the background coloration or residual stain can be reduced significantly. At these low levels, the low-density image area coloration of the imaging layer does not detract unacceptably from the quality of the image. In addition, thiols thioketones, trihalomethyl compounds, lophine dimer compounds, iodonium salts, sulfonium salts, azinium salts, organic peroxides, and azides are examples of compounds useful as polymerization accelerators.

Other additives which can be incorporated into the photopolymerization composition of the invention include various ultraviolet ray absorbers and hindered amine light stabilizers, photostabilizers as described in detail by J. F. Rabek in “Photostabilization of Polymers, Principles and Applications” published by Elsevier Applied Science in 1990.

The imaging element of the invention comprises a support and above the support a light sensitive and heat developable image forming unit or light and pressure developable image forming unit. In one embodiment a multicolor image can be realized using an imaging element produced by producing a plurality of single-color image forming layers within the image forming unit, each of which contains microcapsules enclosing a color-forming component A designed to form a different color, and irradiating the imaging element with a plurality of light sources each having a different wavelength. That is, the light sensitive and heat developable imaging layer or light sensitive and pressure developable imaging layer has a structure produced by providing on a support a first imaging layer which contains microcapsules containing a color-forming component for developing a yellow color and a photopolymerization composition sensitive to a light source having a central wavelength of λ₁, providing on top of the first imaging layer a second imaging layer which contains microcapsules containing a color-forming component for developing a magenta color and a photopolymerization composition sensitive to a light source having a central wavelength of λ₂, and providing on top of second imaging layer a third imaging layer which contains microcapsules containing a color-forming component for developing a cyan color and a photopolymerization composition sensitive to a light source having a central wavelength of λ₃. In addition, if necessary, the imaging layer may have an intermediate layer between the different colored imaging layers. The above-mentioned central wavelengths λ₁, λ₂, and λ₃ of the light sources differ from each other.

The light sensitive and heat developable image forming unit layer or light sensitive and pressure developable image forming unit of the present invention may have any number of the imaging layers. Preferably, the imaging layer may contain first to i^{th} layers, each layer is sensitive to light having a central wavelength different from the light having a central wavelength to which other layers are sensitive, and each layer develops a color different from that of other layers. For example, the first imaging layer is sensitive to light having a central wavelength of λ₁ and develops a color, a second imaging layer is sensitive to light having a central wavelength of λ₂ and develops a color different from the color of the first imaging layer, and an i^{th} imaging layer is sensitive to light having a central wavelength of λᵢ and develops a color different from the colors of i-1^{th} imaging layer.

The multicolor image can also be realized using an imaging element by producing a multicolor image forming unit in which all of the microcapsules are in one layer. The layer contains microcapsules of which each type contains a color-forming component A of a different color, is sensitive to light having a central wavelength different from the light having a central wavelength to which other types of microcapsules are sensitive, and develops a color different from the color other types develop. For example, the first type of microcapsule is sensitive to light having a central wavelength of λ₁ and develops a color, a second type is sensitive to light having a central wavelength of λ₂ and develops a color different from the color of the first type of microcapsules, and an i^{th} type of microcapsules is sensitive to light having a central wavelength of λᵢ and develops a color different from the colors of i-1^{th} type of microcapsules. In the present invention, i is preferably any integer selected from 1 to 10, more preferably any integer selected from 2 to 6, and most preferably any integer selected from 2 to 4.

When images are formed using an imaging material having a multicolor image forming unit like the one for use in the present invention, the exposure step consists of image-wise exposure using plural light sources whose wavelengths match the absorption wavelengths of the imaging layers, respectively, and are different from each other. This exposure enables the imaging layers whose absorption wavelengths match the wavelengths of the respective light sources to form latent images selectively. Because of this, multicolor images can be formed with a high sensitivity and in high sharpness. Furthermore, since the background, which is colored with such compounds as a spectral sensitizing compound and a photopolymerization initiator, can be decolorized by irradiating the imaging layer surface with light, high-quality images having a high contrast can be formed.

The light sensitive and heat developable or light sensitive and pressure developable image forming unit or imaging layers of the invention also contain a binder material. There is no limitation on the choice of the binder material as far as it is compatible with other components incorporated in the layer or unit. The binder material includes, for example, water-soluble polymers, water dispersible polymers, and latex. Specific examples include proteins, protein derivatives, cellulose derivatives (e.g. cellulose esters), polysaccharides, casein, and the like, and synthetic water permeable colloids such as poly(vinyl lactams), acrylamide polymers, poly(vinyl alcohol) and its derivatives, hydrolyzed polyvinyl acetates, polymers of alkyl and sulfoalkyl acrylates and methacrylates, polyamides, polyvinyl pyridine, acrylic acid polymers, maleic anhydride copolymers, polyalkylene oxide, methacrylamide copolymers, polyvinyl oxazolidinones, maleic acid copolymers, vinyl amine copolymers, methacrylic acid copolymers, acryloyloxyalkyl sulfonic acid copolymers, vinyl imidazole copolymers, vinyl sulfide copolymers, and homopolymer or copolymers containing styrene sulfonic acid. Binder also include dispersions made of solvent soluble polymers such as polystyrene, polyvinyl formal, polyvinyl butyral, acrylic resins, e.g., polymethyl acrylate, polybutyl acrylate, polymethyl methacrylate, polybutyl methacrylate, and copolymers thereof, phenol resins, styrene-butadiene resins, ethyl cellulose, epoxy resins, and urethane resins, and latices of such polymers.

The binder is preferably cross-linked so as to provide a high degree of cohesion and adhesion. Cross-linking agents or hardeners which may effectively be used in the coating compositions of the present invention include aldehydes, epoxy compounds, polyfunctional aziridines, vinyl sulfones, methoxyalkyl melamines, triazines, polyisocyanates, dioxane derivatives such as dihydroxydioxane, carbodiimides, chrome alum, zirconium sulfate, and the like.

The light sensitive and heat developable or light sensitive and pressure developable image forming unit or imaging layer thereof may also contain various surfactants for such purposes as a coating aid, an antistatic agent, an agent to improve sliding properties, an emulsifier, an adhesion inhibitor.

Examples of the surfactant that can be used include nonionic surfactants such as saponin, polyethylene oxide, and polyethylene oxide derivatives, e.g., alkyl ethers of polyethylene oxide; anionic surfactants such as alkylsulfonates, alkylbenzenesulfonates, alkylnaphthalenesulfonates, alkylsulfuric esters, N-acyl-N-alkyltaurines, sulfosuccinic esters, and sulfoalkylpolyoxyethylene alkylphenyl ethers: amphoteric surfactants such as alkylbetaines and alkylsulfobetaines: and cationic surfactants such as aliphatic or aromatic quaternary ammonium salts.

Furthermore, if necessary the light and heat sensitive or light sensitive and pressure developable image forming unit or an imaging layer thereof may contain additives other than those described above. For example, dyes, ultraviolet absorbing agents, plasticizers, fluorescent brighteners, matting agents, coating aids, hardeners, antistatic agents, and sliding property-improving agents. Typical examples of these additives are described in Research Disclosure, Vol. 176 (December 1978, Item 17643) and Research Disclosure, Vol. 187 (November 1979. Item 18716).

In the imaging element of the present invention, the imaging material uses color-forming component which is encapsulated in microcapsules. For the encapsulation, a conventionally known method can be employed. Examples of the method include a method utilizing coacervation of a hydrophilic wall-forming material described in U.S. Pat. Nos. 2,800,457 and 2,800,458; an interfacial polymerization method described in U.S. Pat. No. 3,287,154; U.K. Patent 990.443: and JP-B Nos. 38-19574; 42-446, and 42-771; a method utilizing polymer deposition described in U.S. Pat. Nos. 3,418,250 and 3,660,304; a method utilizing an isocyanate-polyol wall-forming material described in U.S. Pat. No. 3,796,669; a method utilizing an isocyanate wall-forming material described in U.S. Pat. No. 3,914,511; a method utilizing urea-formaldehyde and urea-formaldehyde-resorcinol wall-forming materials described in U.S. Pat. Nos. 4,001,140; 4,087,376: and 4,089,802; a method utilizing wall-forming materials such as a melamine-formaldehyde resin and hydroxypropylcellulose described in U.S. Pat. No. 4,025,455; an in-situ method utilizing a polymerization of monomers described in JP-B No. 36-9168 and JP-A No. 51-9079; a method utilizing electrolytic dispersion cooling described in U. K. Patents 952,807 and 965,074; and a spray-drying method described in U.S. Pat. No. 3,111,407 and U. K. Patent 930,442.

The encapsulating method is not limited to the methods listed above. However, in the imaging material of the present invention, it is particularly preferable to employ an interfacial polymerization method comprising the steps of mixing an oil phase, prepared by dissolving or dispersing the color-forming component in a hydrophobic organic phase that becomes the core of the microcapsules, and an aqueous phase having a water-soluble polymer dissolved therein, emulsifying the mixture by means of a homogenizer or the like, and heating the emulsion so as to cause a polymer-forming reaction at the interface of droplets so that polymeric microcapsule walls are formed. This method makes it possible to form microcapsules having uniform particle diameters in a short period of time and to obtain an imaging material excellent in storability as a raw imaging material.

The reactants that form the polymer are added to the inside of the droplets and/or the outside of the droplets. Examples of the polymeric substance include polyurethane, polyurea, polyamide, polyester, polycarbonate, urea/formaldehyde resins, melamine resins, polystyrene, styrene/methacrylate copolymers, styrene/acrylate copolymers, and so on. Among these substances, polyurethane, polyurea, polyamide, polyester, and polycarbonate are preferable, and polyurethane and polyurea are particularly preferable. The above-listed polymeric substances may be used in combinations of two or more kinds.

The water-soluble polymer, which is present as protective colloids in the aqueous phase to be mixed with the oil phase, may be selected appropriately from conventionally known anionic polymers, nonionic polymers, and amphoteric polymers. Examples of the anionic polymer that can be used include natural ones and synthetic ones. Some examples are polymers having such groups as —COO—, —SO₂—, and the like. Specific examples thereof include naturally occurring substances such as gum arabic, alginic acid, and pectin; semisynthetic products such as carboxymethyl cellulose, gelatin derivatives, e.g., phthalated gelatin, sulfated starch, sulfated cellulose, and ligninsulfonic acid; and synthetic products such as maleic anhydride-based (including hydrolysate) copolymers, acrylic acid-based (including methacrylic acid-based) polymers and copolymers, vinylbenzenesulfonic acid-based polymers and copolymers, and carboxy-modified polyvinyl alcohol. Examples of the nonionic polymer include polyvinyl alcohol, hydroxyethyl cellulose, and methylcellulose. Examples of the amphoteric polymer include gelatin and the like. The water-soluble polymers are used as 0.01 to 10% by mass solutions.

A surfactant can also be incorporated in the aqueous phase. The surfactant can be suitably selected from anionic or nonionic surfactants that do not cause precipitation or flocculation by interacting with the protective colloids. Preferred examples of the surfactant include sodium alkylbenzenesulfonate, sodium alkylsulfate, sodium dioctylsulfosuccinate, and polyalkylene glycol (e.g., polyoxyethylene nonylphenyl ether).

When polyurethane is used as a microcapsule wall material, the microcapsule wall can be formed by mixing a polyvalent isocyanate and a second substance (e.g., polyol or polyamine) that reacts therewith to form the microcapsule wall in a water-soluble polymer aqueous solution (i.e., aqueous phase) or in an oily medium (oil phase) to be encapsulated, emulsifying the mixture, and heating the resulting emulsion so as to cause a polymer-forming reaction at the interface of droplets. As the polyvalent isocyanate and the polyol or polyamine, with which the polyvalent isocyanate reacts, those which are described in U.S. Pat. No. Nos. 3,281,383; 3,773,695; and 3,793,268; and JP-B Nos. 48-40347 and 49-24159, and JP-A Nos. 48-80191 and 48-84086 can be used.

When microcapsules containing the color-forming component are prepared, the color-forming component to be enclosed in the microcapsules may be present in a solution state or may be present in solid state inside the microcapsules at room temperature. If it is in the solution state, the color-forming component is mixed with an organic solvent having high boiling point to form the microcapsule core. If it is in the solid states, the color former is dissolved in a thermal solvent or an auxiliary solvent. An auxiliary solvent is removed after encapsulation. The microcapsule core comprises mostly the color-forming component together with other additives. The thermal solvent is a solid at room temperature and becomes a liquid at elevated temperatures, for example, at curing temperatures during the encapsulation process. In this case, the microcapsule core comprises the color-forming component dispersed in a thermal solvent.

A thermal solvent in this invention is defined as compounds which is a solid at temperatures of less than 30° C. and become a liquid at temperatures of greater than 30° C. preferably greater than 40° C. Typical thermal solvents include 1,12-dihydroxydodecane, paraffin wax, bees wax, fatty acid, fatty acid amide, stearic acid, steramide, zinc stearate and more preferably hindered phenols such as 2,6-di-t-butyl-4-methylphenol (BHT), thiodiethylene hydrocinnamate (IRGANOX™ 1035 from Ciba Geigy-Corp.) tetrakis methane (IRGANOX™ 1010 from Ciba Geigy Corp.), bisphenol A diacetate (BPADA), diphenyl phthalate, dicyclohexyl phthalate,′ diphenyl oxalate, benzyl oxynaphthalene, 1-hydroxy-2-naphthoate,- rosin and in terphenyl derivatives, bis-dialkylaryl ethane such as 1,2-bis(3,4-dimethylphenyl)ethane, those disclosed in U.S. Pat. Nos. 4,885,271 and 4,885,271.

In a preferred embodiment of the invention, the color-forming component is mixed together with a photopolymerization composition to form the microcapsule core, or microcapsule internal phase. The microcapsule shell or the microcapsule wall material is a polyurea, or polyurethane-urea. In another preferred embodiment of the invention, the color-forming component is mixed together with a photolymerization composition to form the microcapsule core, or microcapsule internal phase. The microcapsule shell or the microcapsule wall material comprises a polyurea shell or a polyurethane-urea shell and a melamine-formaldehyde or urea-formaldehyde shell.

Preferably the microcapsule containing the color-forming component A is prepared by the steps of dissolving the color-forming component A in an auxiliary organic solvent such as ethyl acetate, or a thermal solvent, or the a photopolymerization composition to form a solution, adding to the solution a certain amount of a microcapsule wall material such as a polyfunctional isocynate to form the oil phase, adding the oil phase to an aqueous solution comprising a water soluble polymer such as polyvinyl alcohol or phthalated gelatin as the protective colloid, and optionally a surfactant, to form a mixture, emulsifying the mixture with a homogenizer to form an emulsion, optionally adding to the emulsion a polyfunctional amine as the curing agent, and curing the emulsion at elevated temperature to form the microcapsule.

If it is desirable to form a second shell, an aqueous solution of melamine and formaldehyde or a precondensate is added to the above emulsion. The melamine-formaldehyde shell is formed by raising the temperature of the resulting mixture at neutral or acidic pH. e.g., pH of 7 or less. The temperature of encapsulation is maintained at about 20 to 95° C. preferably about 30 to 85° C., and more preferably about 45 to 80° C.

The average particle diameter of the microcapsules for use in the imaging material of the present invention is preferably 20 μm or less, more preferably 10 μm or less, and most preferably 6 μm or less from the standpoint of obtaining high resolution. The average particle diameter is preferably 0.1 μm or greater because, if the average particle diameter of tile microcapsules is too small, the surface area per unit amount of the solid components becomes larger and a lager amount of wall-forming materials is required.

The imaging element of the invention preferably comprises an inner protective layer overlaying the image forming unit, i.e., on the opposite side of the image forming unit from the support and an outer protective layer overlaying the inner protective layer. The outermost protective layer protects the imaging element against scratches, pressure marks, cinch marks, and water resistance. The inner protective overcoat layer protects the imaging elements from damage by ultraviolet rays. The inner protective layer also act as a cushioning layer to protect the image element from damage by handling. The two-layer format also provides significant gloss improvement over a single protective layer.

It is preferred that the outer protective overcoat layer has a modulus greater than the modulus of the inner protective layer. i.e., that the inner layer be softer than the outer layer. Preferably the inner protective overcoat layer has a Young's modulus less than 3 Gpa, and the outer protective layer has a Young's modulus greater than 3 Gpa. The Young's modulus ratio of the outer protective layer to inner protective layer is preferably greater than 1.2, and more preferably greater than 1.5. The thickness of the outer protective layer ranges from 0.1 to 6 μm, and preferably from 0.3 to 4 μm, and more preferably from 0.5 to 3 μm. The thickness of the inner protective layer is greater than 0.5 μm, and preferably greater than 1 μm, and more preferably from 2 to 15 μm. The ratio of inner protective layer thickness to the outer protective layer thickness is greater than 1.

The inner protective overcoat layer preferably comprises a hydrophilic colloid. The hydrophilic colloid useful for the present invention includes both synthetic and natural water soluble polymers. Preferably the hydrophilic polymers suitable for use in the present invention further comprise either a chemical moiety capable of capable of forming a covalent chemical bond with a cross-linker. Naturally occurring substances include proteins, protein derivatives, cellulose derivatives (e.g., cellulose esters), polysaccharides, casein, and the like, and synthetic water permeable colloids include poly(vinyl lactams), acrylamide polymers, poly(vinyl alcohol) and its derivatives, hydrolyzed polyvinyl acetates, polymers of alkyl and sulfoalkyl acrylates and methacrylates, polyamides, polyvinyl pyridine, acrylic acid polymers, maleic anhydride copolymers, polyalkylene oxide, methacrylamide copolymers, polyvinyl oxazolidinones, maleic acid copolymers, vinyl amine copolymers, methacrylic acid copolymers, acryloyloxyalkyl sulfonic acid copolymers, vinyl imidazole copolymers, vinyl sulfide copolymers, homopolymer or copolymers containing styrene sulfonic acid, and the like. Gelatin is the most preferred hydrophilic colloid for the present invention.

The inner protective overcoat layer may further comprise a water dispersible resin. Resins which can be used in the protective coating of the present invention include those having film-forming properties. When formed into a film by drying or curing, the resin should be essentially transparent and remain transparent over a broad temperature range without clouding or yellowing. The resin film should also impart scratch resistance, water resistance, gloss, and durability to the protective coating. Examples of water-dispersible resins include acrylic latex (e.g., acrylic ester, modified acrylic ester, acrylic ester copolymer, modified acrylic ester copolymer) and other polymer latices (e.g., styrene-butadiene copolymer, styrene-maleic anhydride copolymer, butadiene-methacrylate copolymer, vinylacetate-vinyl chloride-ethylene copolymer, vinylidene chloride-acrylonitrile copolymer, etc.). In one embodiment, the resin used in the protective coating is an acrylic latex. Examples of acrylic latices, include but are not limited to, acrylic esters, modified acrylic esters, acrylic ester co-polymers, and modified acrylic ester copolymers. In another embodiment of the invention, the resin used in the protective overcoat is a water dispersible polyurethane, or an acrylic-polyurethane hybrid.

The outer protective overcoat layer may comprise the same hydrophilic colloids and water dispersible resins as described above for the inner protective layer. Cross-linking agents may be incorporated into the inner and outer protective coating composition, depending on the types of polymer used, to ensure that the protective coating provides the desired properties, namely water resistance, scratch resistance, and gloss. Examples of preferred cross-linking agents used in the protective coating include, but are not limited to, polyvalent aldehyde compounds such as glyoxal, glutaraldehyde, and derivatives of those compounds which retain free aldehyde groups. Glyoxal is the preferred polyaldehyde. Other cross-linking agents useful in the present invention include di-isocyanate compounds, epoxy compounds, bis-ethyleneimine compounds, divinyl compounds (e.g., divinylbenzene), methacrylic (or acrylic) ester of polyhydric alcohol (e.g., TMPTA), allylglycidyl ether, di-epoxide of polyhydric alcohol, methacrylic anhydride, N-methylolacrylamide, organic peroxide, diamine compounds, bis-2-oxazoline compounds, polymers having 2-oxazoline group, and polymer having carbodiimide group. The cross-linking agent is typically present in an amount from about 2% to 20%, and preferably from about 4% to 10%, based on total solids content of the protective coating.

The inner protective layer and the outer protective layer may further include other additional components such as surfactants, UV absorbing compounds, light stabilizers, pigments, matting agents, fillers, etc. Inclusion of surfactants as wetting agents allows the aqueous coating solution to spread uniformly across the photosensitive layer's surface and produce a smooth coating. Generally, the amount of wetting agent in the coating solution should be from about 1% to about 10% by weight of the coating solution, more preferably from about 4% to about 8%. Examples of wetting agents include diakyl sulfosuccinate sodium salt and anion fluoroalkyl type surfactants. These surfactants are commercially available from Kao Corp, (PELEX OTP) and Dainippon Ink Chemicals, Inc. (Megafac F140NK), respectively.

Preferably the UV absorbing compounds are in the inner protective layer. Such compounds improve the light resistance and stability of the image media. The types of ultraviolet ray absorbers, which can be used for the practice of the present invention, are not particularly limited, provided their absorption maximum wavelengths fall within the range of 300 to 400 nm, and they have no harmful effect on the imaging properties of the element. Such UV dyes include ultraviolet absorbers of the thiazolidone type, the benzotriazole type, the cinnamic acid ester type, the benzophenone type, and the aminobutadiene type and have been described in detail in, for example, U.S. Pat. Nos. 1,023,859; 2,685,512; 2,739,888; 2,748,021; 3,004,896; 3,052,636; 3,215,530; 3,253,921; 3,533,794; 3,692,525; 3,705,805; 3,707,375; 3,738,837; and 3,754,919: and British Patent 1,321,355. Preferably the UV absorber is a benzotriazole compound and, in particular, a high molecular weight benzotriazole emulsion. A specific material this type is ULS-1383 MG available from Ipposha Oil. The amount of the ultraviolet absorbing compound is not limited specifically: it is desirable to adjust the amount preferably to 5% to 30% based on total solids content of the protective coating.

The outer protective layer may further comprise a stiff filler that has a modulus greater than 10 Gpa. Representative stiff fillers include colloidal silica, colloidal tin oxide, colloidal titanium dioxide, mica, clays, doped-metal oxides, metal oxides containing oxygen deficiencies, metal antimonates, conductive nitrides, carbides, or borides, for example, TiO₂, SnO₂, Al₂O₂, ZrO₃, In₂O₂, MgO, ZnSb₂O₂, InSbO₂, TiB₂, ZrB₂, NbB₂, TaB₂, TaB₂, CrB₂, MoB, WB, LaB₆, ZrN, TiN, TiC, and WC. Preferably, the stiff filler has a refractive index less than or equal to 2.1, and most preferably less than or equal to 1.6. It is important to limit the refractive index of the filler in order to provide good transparency of the layer. Preferably the outer protective layer comprises greater than 10%. more preferably than 15% stiff filler. It is important to limit the refractive index of the filler in order to provide good transparency of the laver. The filler also has a particle size less than or equal to 500 nm, and preferably, less than 100 nm.

The outer protective layer may further comprise a pigment to improve handling and to prevent blocking. The pigment is defined to have a particle size of greater than 0.5 μm. Examples of the pigment may include inorganic pigments such as calcium carbonate, zinc oxide, titanium dioxide, silicone dioxide, aluminum hydroxide, barium sulfate, zinc sulfate, talc, kaolin, clay, and colloidal silica, and organic pigments such as styrene microballs, nylon powder, polyethylene powder, urea-formaldehyde resin filler, and raw starch particles.

The outer protective layer may further comprise a lubricant. Examples of lubricants include (1) silicone-based materials disclosed, for example, in U.S. Pat. Nos. 3,489,567; 3,080,317; 3,042,522; 4,004,927; and 4,047,958; and in British Patent Nos. 955,061 and 1,143,118; (2) higher fatty acids and derivatives, higher alcohols and derivatives, metal salts of higher fatty acids, higher fatty acid esters, higher fatty acid amides, polyhydric alcohol esters of higher fatty acids, etc., disclosed in U.S. Pat. Nos. 2,454,043: 2,732,305: 2,976,148; 3,206,311: 3,933,516; 2,588,765; 3,121,060; 3,502,473; 3,042,222; and 4,427,964; in British Patent Nos. 1,263,722: 1,198,387; 1,430,997: 1,466,304: 1,320,757; 1,320,565: and 1,320,756: and in German Patent Nos. 1,284,295 and 1,284,294; (3) liquid paraffin and paraffin or wax like materials such as carnauba wax, natural and synthetic waxes, petroleum waxes, mineral waxes, and the like (4) perfluoro- or fluoro- or fluorochloro-containing materials, which include poly(tetrafluoroethlyene), poly(trifluorochloroethylene), poly(vinylidene fluoride, poly(trifluorochloroethylene-co-vinyl chloride), poly(meth)acrylates or poly(meth)acrylamides containing perfluoroalkyl side groups, and the like. Lubricants useful in the present invention are described in further detail in Research Disclosure No.308. published December 1989. page 1006.

The imaging element of the invention may further comprise at least one non-imaging layer comprising a hydrophilic colloid located between the support and the imaging unit. Examples of suitable hydrophilic colloids include both synthetic and natural water soluble polymers. Preferably the hydrophilic polymers suitable for use in the present invention further comprise either a chemical moiety capable of capable of forming a covalent chemical bond with a cross-linker. Naturally occurring substances include proteins, protein derivatives, cellulose derivatives (e.g., cellulose esters), polysaccharides, casein, and the like, and synthetic water permeable colloids include poly(vinyl lactams), acrylamide polymers, poly(vinyl alcohol) and its derivatives, hydrolyzed polyvinyl acetates, polymers of alkyl and sulfoalkyl acrylates and methacrylates, polyamides, polyvinyl pyridine, acrylic acid polymers, maleic anhydride copolymers, polyalkylene oxide, methacrylamide copolymers, polyvinyl oxazolidinones, maleic acid copolymers, vinyl amine copolymers, methacrylic acid copolymers, acryloyloxyalkyl sulfonic acid copolymers, vinyl imidazole copolymers, vinyl sulfide copolymers, homopolymer or copolymers containing styrene sulfonic acid, and the like. Gelatin is the most preferred hydrophilic colloid for the present invention.

The non-imaging layer may further comprise a latex or a water dispersible resin. Resins which can be used in the non-imaging layer of the present invention include those having film-forming properties. When formed into a film by drying or curing, the resin should be essentially transparent and remain transparent over a broad temperature range without clouding or yellowing. Examples of water-dispersible resins include acrylic latex (e.g., acrylic ester, modified acrylic ester, acrylic ester copolymer, modified acrylic ester copolymer) and other polymer latices (e.g. styrene-butadiene copolymer, styrene-maleic anhydride copolymer, butadiene-methacrylate copolymer, vinylacetate-vinyl chloride-ethylene copolymer, vinylidene chloride-acrylonitrile copolymer. etc.). In one embodiment, the binder used in the non-imaging layer is an acrylic latex. Examples of acrylic latices include, but are not limited to, acrylic esters, modified acrylic esters, acrylic ester co-polymers, and modified acrylic ester copolymers. In another embodiment of the invention, the binder used in the non-imaging layer is a water dispersible polyurethane, or an acrylic-polyurethane hybrid. In one embodiment the non-imaging layer may comprise a cross-linker as described above for the protective layers.

If necessary, an antihalation layer may be provided on the surface of the support to be used. The imaging element may also comprise an antistatic layer, preferably on the back of the support, i.e., the opposite side of the support from the imaging unit. Further, a sliding layer, a curl-preventive layer, an adhesive layer, or the like may be provided on the back of the support to be used. Further, if necessary, an adhesive layer may be provided between a support and the light sensitive and pressure developable image forming unit such that the support is used as a peel paper to thereby provide an aspect having a seal.

When an antihalation layer is provided between a support and the light sensitive and pressure-developable image forming unit or alternatively, on the support surface facing the side having image forming unit in the case of a transparent support, the antihalation layer may be one that can be bleached by irradiation with light or by the application of heat.

For the preparation of a layer that can be bleached by irradiation with light, for example, a combination of the organic dye and organic borate compound described previously can be used. For the preparation of a layer that can be bleached by heat, for example, a composition in which the heat generates a base or nucleophile capable of bleaching the organic dye that is present can be utilized.

Examples of the support for use in the imaging material of the present invention include paper, coated paper; synthetic paper such as laminated paper; films such as polyethylene terephthalate film, cellulose triacetate film, polyethylene film, polystyrene film, and polycarbonate film; plates of metals such as aluminum, zinc, and copper; and these supports whose surface is treated with a surface treatment, a subbing layer or metal vapor deposition. A further example is the support described in Research Disclosure, Vol. 200 (December 1980, Item 20036 XVII). These supports may contain a fluorescent brightener, a bluing dye, a pigment, or other additives. Furthermore, the support itself may be made of an elastic sheet such as a polyurethane foam or rubber sheet. Between a support and the light sensitive and heat developable or the light sensitive and pressure developable image forming unit, a layer which comprises a polymer such as gelatin, polyvinyl alcohol (PVA) or the like, having a low oxygen transmission rate, can be provided. The presence of this layer makes it possible to effectively prevent the fading due to photooxidation of the images formed.

The image element of the present invention can contain at least one electrically conductive layer, which can be either surface protective layer or a sub layer. The surface resistivity of at least one side of the support is preferably less than 1×10¹² \overline{Ω}square, more preferably less than 1×10¹¹ \overline{Ω}square at 25° C. and 20 percent relative humidity. To lower the surface resistivity, a preferred method is to incorporate at least one type of electrically conductive material in the electrically conductive layer. Such materials include both conductive metal oxides and conductive polymers or oligomeric compounds. Such materials have been described in detail in, for example, U.S. Pat. Nos. 4,203,769; 4,237,194; 4,272,616: 4,542,095; 4,582,781; 4,610,955; 4,916,011; and 5,340,676.

The image element of the invention can contain a curl control layer or a backing layer located opposite of the support to the imaging forming unit for the purposes of improving the machine-handling properties and curl of the recording element, controlling the friction and resistivity thereof, and the like. Typically, the backing may comprise a binder and a filler and optionally a lubricant. Typical fillers include amorphous and crystalline silicas, poly(methyl methacrylate), hollow sphere polystyrene beads, micro-crystalline cellulose, zinc oxide, and talc. The filler loaded in the backing is generally less than 5 percent by weight of the binder component, and the average particle size of the filler material is in the range of 1 to 30 μm. Examples of typical binders used in the backing are polymers such as polyacrylates, gelatin, polymethacrylates, polystyrenes, polyacrylamides, vinyl chloride-vinyl acetate copolymers, poly(vinyl alcohol), gelatin, and cellulose derivatives. Lubricants can be same as those incorporated in the outer protective layer located in the opposite side to the backing layer. Additionally, an antistatic agent also can be included in the backing to prevent static hindrance of the image element. Particularly suitable antistatic agents are compounds such as dodecylbenzenesulfonate sodium salt, octylsulfonate potassium salt, oligostyrenesulfonate sodium salt and laurylsulfosuccinate sodium salt, and the like. The antistatic agent may be added to the binder composition in an amount of 0.1 to 15 percent by weight, based on the weight of the binder. An image forming unit may also be coated on the backside, if desired.

The imaging element of the present invention can be prepared by a process comprising the steps of preparing a coating liquid for forming a light sensitive and pressure developable image forming unit or the separate imaging layers, a coating liquid for forming protective layers or intermediate layer by, for example, dissolving the respective constituent components in solvents, applying the coating liquids successively onto a desired support, and drying the coating layers. Examples of the solvent that can be used for the preparation of the coating liquids include water; alcohols such as methanol, ethanol, n-propanol, isopropanol, n-butanol, sec-butanol, methyl cellosolve, and 1-methoxy-2-propanol; halogen-based solvents such as methylene chloride and ethylene chloride; ketones such as acetone, cyclohexanone, and methyl ethyl ketone; esters such as methyl cellosolve acetate, ethyl acetate, and methyl acetate; toluene; xylene; and a mixture of two or more thereof. Among these solvents, water is particularly preferable.

When applying the coating liquid for forming an image forming unit or imaging layer onto the support, a blade coater, a rod coater, a knife coater, a roll-doctor coater, a reverse roll coater, a transfer roll coater, a gravure coater, a kiss roll coater, a curtain coater, an extrusion coater, etc., can be used. The application can be carried out using the coating method described in Research Disclosure, Vol. 200 (December 1980, Item 20036 XV). The thickness of the image forming unit is preferably in the range of 0.1 to 50 μm, more preferably in the range of 5 to 35 μm, and most preferably in the range of 10 to 30 μm.

Visible images can be made by heat development if the imaging element of the present invention is a light sensitive and heat-developable imaging element or by pressure development if the imaging element of the present invention is a light sensitive and pressure developable imaging material. The heat or pressure development can be carried out either simultaneously with the exposure for latent image formation or after the exposure.

A conventionally known heating method can be employed for the heat development. Generally, the heating temperature is preferably 80 to 200° C., more preferably 83 to 160° C., and most preferably 85 to 130° C. The duration of heating is preferably in the range of 3 seconds to 1 minute, more preferably in the range of 4 to 45 seconds, and most preferably in the range of 5 to 30 seconds.

The pressure development can be accomplished with a pressure applicator device. For example, the imaging material is developed by passing an exposed imaging media between a pair of calendar rollers that rupture the microcapsules, thereby allowing contact between the color-forming component and a developer that react to develop the image. The imaging material can also be developed by moving a point contact which is resiliently biased into engagement with the imaging sheet. Typically, the imaging sheet is secured to a cylinder and the point contact is positioned in resilient pressure contact with the imaging sheet. As the cylinder is rotated, the point contact is simultaneously moved along the cylinder in synchronism with the rotation of the cylinder to rupture the microcapsules and develop the image in the imaging sheet, or the imaging sheet may be mounted on a planer platform and the point contact is moved across the surface of the sheet using a screw thread in an X-Y transport device. The pressure that is to be applied is preferably 10 to 300 kg/cm², more preferably 80 to 250 kg/cm², and most preferably 130 to 200 kg/cm². If the pressure is less than 10 kg/cm², sufficient density of developed color may not be obtained whereas, if the pressure exceeds 300 kg/cm², the discrimination of the images may not be sufficient because even the hardened microcapsules are broken.

The imaging element of the present invention comprises a photopolymerization initiator or the like such as a spectral sensitizing. Therefore, the imaging, element of the present invention is colored with the photopolymerization initiator or the like. Since background is also colored with the compound, it is very important for the method of the present invention that the colored background is decolorized by irradiation after heat development.

Accordingly, it is preferable that, after the heat development, the image forming unit surface is irradiated with light to fix the images formed and to decolorize, decompose, or deactivate the components such as a spectral sensitizing compound which remain in the imaging layer and decrease the whiteness of the background. By carrying out the irradiation, it is possible to inhibit the coloration reaction. As a result, the density variation in the images can be inhibited, and the image storability can be largely enhanced.

The imaging element of the invention is exposed image-wise to light according to the pattern of a desired image shape so that the photopolymerization forms a latent image. The color development step is accomplished by heat or/and pressure so that the color-forming components develop colors according to the latent image to thereby produce images. The fixing step in which the imaging layer surface is irradiated with light so as to fix the image formed and decolorize the organic dyes.

In the exposure step, it is possible to employ, for example, a means for exposing the whole face to an amount of light which has wavelengths corresponding to the sensitive regions of respective colors and can provide a desired density of the developed color. The light source for use in the exposure step may be any light source selected from the light sources having wavelengths ranging from ultraviolet to infrared light if the light sensitive and heat developable imaging layer contains a light-absorbing material such as a spectral sensitizing compound that exhibits an absorption in a specific wavelength region. More specifically, a light source providing maximum absorption wavelengths ranging from 300 to 1000 nm is preferable. It is preferable to select and use a light source whose wavelength matches the absorption wavelength of the light-absorbing material such as an organic dye to be used. The selective use of such light-absorbing material enables the use of a blue to red light source and the use of a small-sized, inexpensive infrared laser device and consequently, not only broadens the use of the imaging material of the present invention, but also raises sensitivity and image sharpness. Among the light sources, it is particularly preferable to use a laser light source such as a blue, green, or red laser light source or an LED from the viewpoint of simplicity, downsizing, and low cost of the device.

According to the image imaging process of the present invention, after the color development step, the image forming unit surface is subjected to a fixing step in which the whole imaging layer surface is irradiated with light from a specific light source to fix the images formed and to decolorize photopolymerization initiator components remaining in the imaging layer. As for the light source that can be used in the fixing step, a wide range of light sources, such as a mercury lamp, an ultrahigh pressure mercury lamp, an electrodeless discharge-type mercury lamp, a xenon lamp, a tungsten lamp, a metal halide lamp, and a fluorescent lamp, can be suitably used. The method of irradiating the image forming unit with light from the light source in the fixing step is not particularly limited. The whole image forming unit surface may be irradiated with light at one time or the image forming unit surface may be gradually irradiated with light by scanning or the like until the irradiation of the surface finally ends. That is, any method that finally enables the irradiation of the entire surface of the image forming unit material after image formation with nearly uniform light may be employed. The irradiation of the entire image forming unit layer is preferable from the standpoint of the enhancement of the effects of the present invention. The duration of the irradiation with light from the light source needs to be the time period that allows the produced images to be fixed and the background to be sufficiently decolorized. In order to perform sufficient fixing of images and decolorization, the duration of the irradiation is preferably in the range of several seconds to tens of minutes, and more preferably in the range of several seconds to several minutes.

The following examples illustrate the practice of this invention. They are not intended to be exhaustive of all possible variations of the invention.

### EXAMPLES

### Example 1

### Preparation of Developer Zinc Salt of Styrene/Salicylate Resin

Resin 1: Styrene/Methyl Salicylate 4/1

A 22 L, 3-neck flask was fitted with a mechanical stirrer, a nitrogen inlet, and a Claisen adaper. The flask was charged with 3500 ml of dichloroethane, 1522 g of methyl salicylate, and 215 g of concentrated sulfuric acid with stirring at 150 rpm. The reaction mixture was cooled to 0° C., and 4166 g of styrene was added over 240 minutes to control exotherm. The reaction was stirred for 2 hours while the reaction was ramped to 5° C., and 3500 g of distilled water was added over 2 hours. The Claisen adapter was removed and the flask was fitted with a simple distillation head, condenser, and receiver. Dicholoethane was distilled off with some water and the reaction was cooled to 85° C. 1359 g of 50% sodium hydroxide was added slowly over an hiour through the condenser then rinsed with 200 ml of distilled water. The reaction was continued at 85° C. for an additional two hours.

An 80 L stainless steel open tank with steam jacket was charged with 25 L of distilled water and heated to 80° C. with good stirring. The above 85° C. hot solution was added all at once into the stirred tank. 2 L of hot water was used to rinse out the flask into the tank yielding a white mixture. The pH was adjusted to 10.5 with 1 N sulfuric acid. The reaction was cooled to 30° C. and 10 L of ethyl acetate was added. A solution of 1450 g of zinc sulfate heptahydrate in 4 L of water was added over an hour. The mixture was stirred at room temperature overnight. The reaction mixture was transferred to a separatory container and the organic and water phases were slow to separate, often the first organic extract was below the water phase. The aqueous phase was extracted three more times with one to two liters of ethyl acetate. Some sodium hydroxide might be added to the water phase after the first extraction to facilitate the layer partition. The extracts were combined and washed two times with distilled water. The ethyl acetate solution was dried over anhydrous sodium sulfate and filtered through a fiberglass paper. A rotary evaporator was used to concentrate the solution to approximately 60%, solids to give about 9000 g of solution.

Resin 2: styrene/methyl salicylate 3/1

Resin 2 was prepared similarly as resin 1.

Resin 3: styrene/methyl salicylate 5/1

Resin 3 was prepared similarly as resin 1.

### Example 2

### Samples 1-1 through 1-5

An organic phase was prepared whereby developer resin 2 was dissolved in ethyl acetate to prepare 399.0 grams of a 50% weight/weight solution in ethyl acetate. 0.9 grams of Aerosol OT (Cytec Industries) was dissolved into the developer/ethyl acetate mixture and the resulting solution was heated to 50° C. An aqueous composition was prepared such that 62.1 grams of a 10% solution of polyvinyl alcohol (Airvol 205, Air Products, Inc.) was dissolved in 537.9 grains of deionized water and the resulting aqueous phase was heated to 50° C. The aqueous phase was added to the organic phase while mixing with a simple propeller mixer. The resulting premix was then subjected to shear using a Silverson Model rotor stator mixer for 5 minutes at a rotor speed of 5500 rpm.

The resulting aqueous dispersion was transferred to a round bottom flask and the ethyl acetate was removed by rotary evaporation at 68C. under vacuum for minutes. A 100 gram sample of evaporated dispersion was taken and the evaporation process was continued in 10-minute increments and 100 gram samples were taken after each evaporation increment. The resulting aqueous dispersions were cooled to 25° C. and the pH of the suspension was adjusted to 9.0 using a 10% sodium hydroxide solution. The aqueous dispersions were analyzed for weight percent residual ethyl acetate by gas chromatography and gravity filtration was attempted through a nominal 20 μm cutoff filter under.

TABLE 1

| | Evaporation | Grams of | Wt % | |
|---|---|---|---|---|
| | Time | 10% NaOH | residual | Filtration through |
| Example | (minutes) | to pH 9 | ethyl acetate | 20 μm filter |
| 1-1 | 20 | 7.2 | 2.6 | Severe plugging |
| 1-2 | 30 | 1.4 | 1.6 | Severe plugging |
| 1-3 | 40 | 0.7 | 0.6 | Filtered well |
| 1-4 | 50 | 0.8 | 0.2 | Filtered well |
| 1-5 | 60 | 0.8 | 0.06 | Filtered well |

### Example 3

An organic phase was prepared whereby developer resin 1 was dissolved in ethyl acetate to prepare 399.0 grams of a 50% weight/weight solution in ethyl acetate. 0.9 grams of Aerosol OT (Cytec Industries) was dissolved into the developer/ethyl acetate mixture and the resulting solution was heated to 50° C. An aqueous composition was prepared such that 62.1 grams of a 10% solution of polyvinyl alcohol (Airvol 205, Air Products, Inc.) was dissolved in 537.9 grams of deionized water and the resulting aqueous phase was heated to 50° C. The aqueous phase was added to the organic phase while mixing with a simple propeller mixer. The resulting premix was then subjected to shear using a Silverson Model rotor stator mixer for minutes at a rotor speed of 5500 rpm.

The resulting aqueous dispersion was transferred to a round bottom flask and the ethyl acetate was removed by rotary evaporation at 68° C. under vacuum for 45 minutes. The resulting aqueous dispersions were cooled to 25° C. and the pH of the suspension was adjusted to 9.0 using a 10% sodium hydroxide solution. The particle size distribution was measured on a Horiba LA-920 instrument (sizes reported in volume based distribution). The resulting particle size is shown in Table 2.

### Example 4

An organic phase was prepared whereby developer resin 3 was dissolved in ethyl acetate to prepare 287.4 grams of a 50% weight/weight solution in ethyl acetate. 0.7 grams of Aerosol OT (Cytec Industries) was dissolved into the developer-ethyl acetate mixture and the resulting solution was heated to 50° C. An aqueous composition was prepared such that 44.7 grams of a 10% solution of polyvinyl alcohol (Airvol 205. Air Products, Inc.) was dissolved in 387.3 grams of deionized water aid the resulting aqueous phase was heated to 50° C. The aqueous phase was added to the organic phase while mixing with a simple propeller mixer. The resulting premix was then subjected to shear using a Silverson Model rotor stator mixer for minutes at a rotor speed of 5500 rpm.

The resulting aqueous dispersion was transferred to a round bottom flask and the ethyl acetate was removed by rotary evaporation at 68° C. under vacuum for 50 minutes. The resulting aqueous dispersions were cooled to 25° C. and the pH of the suspension was adjusted to 9.0 using a 10% sodium hydroxide solution. The particle size distribution was measured on a Horiba LA-920 instrument (sizes reported in volume based distribution). The resulting particle size is shown in Table 2.

### Example 5

An organic phase was prepared whereby developer resin 2 was dissolved in ethyl acetate to prepare 399.1 grams of a 50% weight/weight solution in ethyl acetate. 0.56 grams of Aerosol OT (Cytec Industries) was dissolved into the developer/ethyl acetate mixture and the resulting solution was heated to 50° C.

An aqueous composition was prepared such that 36.9 grams of a 10% solution of polyvinyl alcohol (Airvol 205, Air Products, Inc.) was dissolved in 563.4 grams of deionized water and the resulting aqueous phase was heated to 50 C. The aqueous phase was added to the organic phase while mixing with a simple propeller mixer. The resulting premix was then subjected to shear using a Silverson Model rotor stator mixer for 5 minutes at a rotor speed of 5500 rpm.

The resulting aqueous dispersion was transferred to a round bottom flask and the ethyl acetate was removed by rotary evaporation at 68° C. under vacuum for 45 minutes. The resulting aqueous dispersions were cooled to 25° C. and the pH of the suspension was adjusted to 9.0 using a 10% sodium hydroxide solution. The particle size distribution was measured on a Horiba LA-920 instrument (sizes reported in volume based distribution). The resulting particle size is shown in Table 2.

TABLE 2
Particle Size for Aqueous Dispersed Developer Compositions

| | | Standard | Diameter at which |
|---|---|---|---|
| | Volume mean | deviation around | 100% of distribution |
| Example | diameter (μm) | Volume mean (μm) | lies below |
| 2 | 1.05 | 0.52 | 4.5 |
| 3 | 1.12 | 0.66 | 5.9 |
| 4 | 1.11 | 0.56 | 5.1 |

### Example 6

### Image Elements

A number of image elements were prepared by coating over a transparent poly(ethylene terephthlate) support an imaging layer comprising the polyvalent metal salt of salicylic acid/styrene copolymer developer particle and a mixture of microcapsules comprising respectively cyan, magenta, and yellow dye forming color precursors and having a particle size of about 4 μm. The imaging layer had a final dry thickness of about 23 μm. Different elements comprise developer particles of various sizes at a given dry coverage. The coated imaging layers were then laminated to a white polyester paper (Melinex 329) pre-coated with a pressure sensitive adhesive layer with the imaging layer facing toward the pressure sensitive layer. The image elements were conditioned, respectively, at 21° C./20% RH, 21° C./50% RH, and 21° C./80% RH for a week before the image was developed under pressure, which was followed by heat using heat hot plates at 90° C. for 10 seconds. The developed density was then read with using an X-Rite 820TR™ Densitometer. The results are listed in Table 3.

TABLE 3
Image Elements

| | | Optical Density at | | | Optical Density at | | | Optical Density at | | |
|---|---|---|---|---|---|---|---|---|---|---|
| Image | Developer | 20% RH | | | 50% RH | | | 80% RH | | |
| Element | Size (μ) | R | G | B | R | G | B | R | G | B |
| 1 | 0.5 | 1.84 | 1.89 | 1.83 | 1.31 | 1.30 | 1.56 | 1.02 | 0.97 | 1.23 |
| 2 | 0.67 | 1.93 | 1.97 | 1.90 | 1.65 | 1.71 | 1.66 | 1.40 | 1.38 | 1.32 |
| 3 | 0.94 | 1.95 | 2.00 | 1.85 | 1.81 | 1.87 | 1.80 | 1.58 | 1.60 | 1.63 |
| 4 | 1.2 | 2.02 | 2.06 | 1.95 | 1.87 | 1.93 | 1.87 | 1.70 | 1.74 | 1.73 |
| 5 | 2.7 | 2.08 | 2.17 | 1.96 | 1.72 | 1.80 | 1.70 | 1.41 | 1.44 | 1.37 |

The results in Table 3 clearly demonstrate that the image elements comprising the developer particles of the invention, i.e,. having a mean size greater than or equal to 0.75 μm and less than or equal to 2.0 μm, have excellent dye developability at all three different relative humidity.

The invention has been described in detail with particular reference to certain preferred embodiments thereof, but it will be understood that variations and modifications can be effected within the spirit and scope of the invention.

1. An aqueous dispersion composition comprising particles of a polyvalent metal salt of salicylic acid/styrene copolymer developer wherein said particles are at least 15% by Weight of the aqueous composition and have an average particle size of greater than or equal to 0.75 μm and less than or equal to 2.0 μm, and wherein less than 2% of the particles are greater than 10 μm, wherein said composition has a pH of greater than 6 and comprises a surfactant and a polymeric dispersant.

2. The composition of claim 1 wherein less than 1% of the particles are greater than 10 μm.

3. The composition of claim 1 wherein said particles are at least 40% by weight of the aqueous composition.

4. The composition of claim 1 wherein the ratio of styrene derivative to salicylate used to make the polyvalent metal salt of salicylic acid/styrene copolymer is 2:1 mols to 7:1 mols.

5. The composition of claim 1 wherein the ratio of styrene derivative to salicylate used to make the polyvalent metal salt of salicylic acid/styrene copolymer is 3:1 mols to 6:1 mols.

6. The composition of claim 1 wherein the composition has a residual auxiliary organic solvent concentration of less than 2% by weight of the aqueous developer composition.

7. The composition of claim 1 wherein the composition has a residual auxiliary organic solvent concentration of less than 1% by weight of the aqueous developer composition.

8. The composition of claim 1 wherein the composition is made by
(a) preparing an organic phase comprising one or more auxiliary solvents, a polyvalent metal salt of salicylic acid/styrene copolymer developer, and a surfactant:
(b) preparing a separate aqueous phase containing a water soluble polyermeric dispersant;
(c) dispersing the organic phase into the aqueous phase to form a dispersed composition; and
(d) removing the auxiliary solvent from the dispersed composition; wherein the pH maintained during the process is greater than 6.

9. The composition of claim 8 wherein the composition has a residual auxiliary solvent concentration of less than 2% by weight of the aqueous developer composition.

10. The composition of claim 8 wherein the composition has a residual auxiliary solvent concentration of less than 1% by weight of the aqueous developer composition.

11. The composition of claim 8 wherein the organic phase comprises at least 40% by weight of the polyvalent metal salt of salicylic acid/styrene copolymer developer.

12. The composition of claim 8 wherein the aqueous phase comprises a water soluble surfactant.

13. The composition of claim 8 wherein the ratio of styrene derivative to salicylate used to make the polyvalent metal salt of salicylic acid/styrene copolymer is 2:1 mols to 7:1 mols.

14. The composition of claim 8 wherein the ratio of styrene derivative to salicylate used to make the polyvalent metal salt of salicylic acid/styrene copolymer is 3:1 mols to 6:1 mols.

15. A process of making an aqueous dispersion of particles of a polyvalent metal salt of salicylic acid/styrene copolymer developer said particles having an average particle size of greater than or equal to 0.75 μm and less than or equal to 2.0 μm, and wherein less than 2% of the particles are greater than 10 μm, said process comprising:
(a) preparing, an organic phase comprising one or more auxiliary solvents, a polyvalent metal salt of salicylic acid/styrene copolymer developer, and a surfactant;
(b) preparing a separate aqueous phase containing a water soluble polyermeric dispersant;
(c) dispersing the organic phase into the aqueous phase to form a dispersed composition; and
(d) removing the auxiliary solvent from the dispersed composition; wherein the pH maintained during the process is greater than 6.

16. The process of claim 15 wherein the organic phase comprises at least 40% by weight of the polyvalent metal salt of salicylic acid/styrene developer.

17. The process of claim 15 wherein the aqueous phase comprises a water soluble surfactant.

18. The process of claim 15 wherein the organic soluble surfactant is a sodium salt of an alkyl sulfosuccinic acid and the water soluble dispersant is polyvinyl alcohol.

19. The process of claim 15 wherein the ratio of styrene derivative to salicylate used to make the polyvalent metal salt of salicylic acid/styrene copolymer is 2:1 mols to 7:1 mols.

20. The process of claim 15 further comprising the step of raising the pH of the composition to greater than 9 after the auxiliary solvent is removed.

21. The process of claim 18 wherein the ratio of styrene derivative to salicylate used to make the polyvalent metal salt of salicylic acid/styrene copolymer is 3:1 mols to 6:1 mols.

22. An imaging element comprising a support and an image forming layer comprising photosensitive microcapsules and a developer comprising particles of a polyvalent metal salt of salicylic acid/styrene copolymer developer said particles having a styrene/salicylic acid ratio of greater than 2:1 mols.

23. The imaging element of claim 22 wherein the particles have a styrene/salicylic acid ratio of greater than 3:1 mols.

24. The imaging element of claim 22 wherein the particles have an average particle size of greater than or equal to 0.75 μm and less than or equal to 2.0 μm, and wherein less than 2% of the particles are greater than 10 μm.

25. The imaging element of claim 24 wherein less than 1% of the particles are greater than 10 μm.

26. The imaging element of claim 22 wherein the ratio of styrene derivative to salicylate used to make the polyvalent metal salt of salicylic acid/styrene copolymer is 2:1 mols to 7:1 mols.

27. The imaging element of claim 22 wherein the ratio of styrene derivative to salicylate used to make the polyvalent metal salt of salicylic acid/styrene copolymer is 3:1 mols to 6:1 mols.

28. The imaging element of claim 22 wherein the developer composition is made by
(a) preparing an organic phase comprising one or more auxiliary solvents, a polyvalent metal salt of salicylic acid/styrene copolymer developer, and a surfactant;
(b) preparing a separate aqueous phase containing a water soluble polyermeric dispersant;
(c) dispersing the organic phase into the aqueous phase to form a dispersed composition; and
(d) removing the auxiliary solvent from the dispersed composition; wherein the pH maintained during the process is greater than 6.

29. The imaging element of claim 28 wherein the aqueous phase comprises a surfactant.

30. The imaging element of claim 22 wherein the imaging element is light sensitive and heat or pressure developable.

31. The imaging element of claim 22 wherein the imaging element is light sensitive and pressure developable.

32. The imaging element of claim 22 wherein the imaging element further comprises an inner protective layer and an outer protective layer oil the opposite side of the image forming unit from the support.

33. The imaging element of claim 22 wherein the imaging element further comprises at least one non-imaging layer comprising a hydrophilic colloid located between the support and the imaging unit.
